(19) United States
(12) Patent Application Publication
(10) Pub. No.: US 2025/0020008 A1
(43) Pub. Date: Jan. 16, 2025

(54) ENTRYWAY PANEL WITH MAGNETIC CLOSURE AND METHODS OF INSTALLATION

(71) Applicant: Zipwall, LLC., Arlington, MA (US)

(72) Inventor: Jeffrey P. Whittemore, Arlington, MA (US)

(21) Appl. No.: 18/710,349

(22) PCT Filed: Nov. 16, 2022
(86) PCT No.: PCT/US22/50032

§ 371 Date: May 15, 2024

Related U.S. Application Data
(60) Provisional application No. 63/282,285, filed on Nov. 23, 2021.

(51) Int. Cl. E05C 19/16; E04G 21/24

(52) U.S. Cl. CPC E05C 19/16; E04G 21/243

(57) ABSTRACT

A magnetic door having a top, a bottom, a left side, and a right side, the magnetic door having an opening extending to the bottom of the magnetic door between the left side and the right side of the magnetic door from a position below the top of the magnetic door, the opening having a left seam and a right seam, the left scam comprising a first magnet, the right seam comprising a second magnet, wherein the first and second magnets are constructed and arranged to be magnetically coupled.

### RELATED APPLICATIONS

This application claims the benefit of:
U.S. Provisional Application Ser. No. 63/282,285, filed Nov. 23, 2021, the content of each being incorporated herein by reference, in its entirety.
   This application is related to:
U.S. Pat. No. 5,924,469, issued on Jul. 20, 1999;
U.S. Pat. No. 6,564,512, issued on May 20, 2003;
U.S. Pat. No. 7,073,758, issued on Jul. 11, 2006;
U.S. Pat. No. 7,533,712, issued on May 19, 2009;
U.S. Pat. No. 7,658,219, issued on Feb. 9, 2010;
U.S. Pat. No. 7,670,401, issued on Mar. 2, 2010;
U.S. Pat. No. 7,743,512, issued on Jun. 29, 2010;
U.S. Pat. No. 7,717,382, issued on May 18, 2010;
U.S. Pat. No. 9,115,539, issued on Aug. 25, 2015;
United States Design Pat. No. D777901, issued on Jan. 31, 2017;
U.S. Pat. No. 9,657,514, issued on May 23, 2017;
U.S. Pat. No. 9,663,962, issued on May 30, 2017;
U.S. Pat. No. 10,081,955, issued on Sep. 25, 2018;
U.S. Pat. No. 10,174,514, issued on Jan. 8, 2019;
U.S. Pat. No. 10,428,539, issued on Oct. 1, 2019;
U.S. Pat. No. 10,781,597, issued on Sep. 22, 2020;
U.S. Pat. No. 11,441,323, issued on Sep. 13, 2022;
U.S. patent application Ser. No. 15/822,423, filed on Nov. 27, 2017, United States Publication No. 2018-0154293, published Jun. 7, 2018;
U.S. patent application Ser. No. 17/416,644, filed on Jun. 21, 2021, United States Publication No. 2022-0162866, published May 26, 2022;
U.S. patent application Ser. No. 17/297,139, filed on May 26, 2021, United States Publication No. 2022-0081963, published Mar. 17, 2022;
U.S. patent application Ser. No. 17/416,646, filed on Jun. 21, 2021, United States Publication No. 2022-0074523, published Mar. 10, 2022;
Patent Cooperation Treaty Application Serial Number PCT/US22/035702, filed on Jun. 30, 2022, PCT Publication No. ______, published ______; and
United States Design patent application Ser. No. 29/815,881, filed on Nov. 17, 2021, U.S. Pat. No. ______, published ______,
the content of each being incorporated herein by reference in its entirety.

### BACKGROUND

Partition systems are often employed to isolate portions of a building or room, by serving as a barrier to dust, noise, light, odors, and the like. In construction zones, partitions are useful for protecting a clean area from a work area, for example, protecting an area where furniture and rugs are temporarily stored from an area where wood floors are being refinished.

Workers at construction sites often use rudimentary techniques for installing partitions. Some simply nail, screw, or staple the curtain or partition material to the floor, ceiling, and abutting walls, resulting in damage to their surfaces. Others tape, or otherwise adhere, a curtain or plastic sheet to the walls and ceilings. The tape usually fails to stick, but if it does stick, as the tape is removed, paint can pull off with the tape, or adhesive is left behind.

U.S. Pat. Nos. 5,924,469 and 7,658,219, the contents of which are incorporated herein by reference, disclose partition mount systems that address these limitations. Such systems are compatible with a variety of commercially-available curtain or drape materials, for example plastic, cloth, and the like. The disclosed systems are “clean” systems designed to be installed and removed without damaging or otherwise marking the ceiling, floor or walls in the construction zone. Assembly is easy and fast and can be accomplished by a single individual.

In some situations, it is desired to have a defined entryway location for ingress into/egress from a partitioned area. In some situations, it is desired to have a defined entryway that is removably coupled to a neighboring curtain or door frame.

### SUMMARY

In accordance with one aspect of the present disclosure, provided is a magnetic door system, comprising a curtain and a magnetic door removably coupled to the curtain. The magnetic door comprising: a first seam, the first seam comprising a first magnet; and a second seam, the second seam comprising a second magnet, wherein he first and second magnets are constructed and arranged to be magnetically coupled. The magnetic door system further comprises an attachment mechanism configured to couple the magnetic door to the curtain, wherein the attachment mechanism is positioned between a surface of the curtain and a surface of the magnetic door.

In various embodiments, the magnetic door is secured to the curtain only by the attachment mechanism.

In various embodiments, the magnetic door is supported only by the curtain and the attachment mechanism.

In various embodiments, the curtain comprises a material selected from a durable material, a ruggedized nylon material, a nylon taffeta, a rip-stop material, a synthetic material, a natural fabric material, a plastic material.

In various embodiments, the magnetic door comprises a material selected from a durable material, a ruggedized nylon material, a nylon taffeta, a rip-stop material, a synthetic material, a natural fabric material, a plastic material.

In various embodiments, the first and second magnets each comprise a plurality of magnets positioned along the left or right seam.

In various embodiments, the left and right seams comprise corresponding magnets at corresponding vertical positions and wherein north and south poles of the corresponding magnets are configured to be of opposite polarity so that the corresponding magnets attract each other.

In various embodiments, the first and second magnets comprise an elongated body having a north pole and a south pole.

In various embodiments, the attachment mechanism comprises a plurality of attachment mechanisms.

In various embodiments, the attachment mechanism comprises a first member and a second member.

In various embodiments, the first member is positioned at the curtain and the second member is positioned between the first member and the magnetic door.

In various embodiments, the first member comprises duct tape and the second member comprises double-sided tape.

In various embodiments, the attachment mechanism comprises double-sided tape.

In various embodiments, the double-sided tape comprises a first side comprising a high-tack adhesive material and a second side comprising a low-tack adhesive material.

In various embodiments, the attachment mechanism secures the magnetic door directly to the curtain.

In accordance with another aspect of the present disclosure, provided is a system, comprising: a curtain constructed and arranged to be positioned between a ceiling and a floor; a magnetic door having a top, a bottom, a left side, and a right side, the magnetic door having an opening extending to the bottom of the magnetic door between the left side and the right side of the magnetic door from a position below the top of the magnetic door, the opening having a left seam and a right seam; a first magnet positioned at the left seam of the opening; a second magnet positioned at the right seam of the opening, wherein the first and second magnets are magnetically attracted; and an attachment mechanism constructed and arranged to secure the magnetic door directly to the curtain such that the magnetic door is secured to the curtain exclusively by the attachment mechanism, wherein the attachment mechanism is positioned between a surface of the curtain and a surface of the magnetic door.

In various embodiments, the magnetic door comprises a material selected from a durable material, a ruggedized nylon material, a nylon taffeta, a rip-stop material, a synthetic material, a natural fabric material, a plastic material.

In various embodiments, the first and second magnets comprise an elongated body having a north pole and a south pole.

In various embodiments, the first and second magnets each comprise a plurality of magnets positioned along the left or right seam.

In various embodiments, the left and right seams comprise corresponding magnets at corresponding vertical positions and wherein north and south poles of the corresponding magnets are configured to be of opposite polarity so that the corresponding magnets attract each other.

In various embodiments, the attachment mechanism comprises a plurality of attachment mechanisms.

In various embodiments, the attachment mechanism comprises a first member and a second member.

In various embodiments, the first member is positioned at the curtain and the second member is positioned between the first member and the magnetic door.

In various embodiments, the first member comprises duct tape and the second member comprises double-sided tape.

In various embodiments, the attachment mechanism comprises double-sided tape.

In various embodiments, the attachment mechanism secures the magnetic door directly to the curtain.

In various embodiments, the attachment mechanism removably secures the magnetic door to the curtain.

In various embodiments, the magnetic door is supported exclusively by the curtain and the attachment mechanism.

In accordance with another aspect of the present disclosure, provided is a magnetic door kit, comprising: a magnetic door having a top, a bottom, a left side, and a right side, the magnetic door having an opening extending to the bottom of the magnetic door between the left side and the right side of the magnetic door from a position below the top of the magnetic door, the opening having a left seam and a right seam, the left seam comprising a first magnet, the right seam comprising a second magnet, wherein the first and second magnets are constructed and arranged to be magnetically coupled; and an attachment mechanism configured to couple the magnetic door to a surface, wherein the attachment mechanism comprises double-sided tape.

In accordance with another aspect of the present disclosure, provided is a method of installing a magnetic door, comprising the steps of: providing a curtain; providing a magnetic door comprising: a first seam, the first seam comprising a first magnet; and a second seam, the second seam comprising a second magnet, wherein the first and second magnets are constructed and arranged to magnetically couple; providing an attachment mechanism configured to couple the magnetic door to the curtain; coupling the attachment mechanism to the curtain; and coupling the magnetic door to the attachment mechanism.

In various embodiments, the method further comprises: providing a first vertical pole and a second vertical pole; coupling a first end of the curtain to the first vertical pole; and coupling a second end of the curtain to the second vertical pole.

In accordance with another aspect of the present disclosure, a system, comprising: a magnetic door having a top, a bottom, a left side, and a right side, the magnetic door having an opening extending to the bottom of the magnetic door between the left side and the right side of the magnetic door from a position below the top of the magnetic door, the opening having a left seam and a right seam, the left seam comprising a first magnet, the right seam comprising a second magnet, wherein the first and second magnets are constructed and arranged to be magnetically coupled, and an attachment mechanism configured to couple the magnetic door to a mounting surface, wherein the magnetic door comprises an aperture.

In various embodiments, the system further comprises a base positioned at the aperture and configured to support an air duct.

In various embodiments, the base is integral with the magnetic door.

In various embodiments, the base comprises a circular shape.

In various embodiments, the base comprises an aperture.

In various embodiments, the base comprises a ring.

In various embodiments, the base comprises half of a ring.

In various embodiments, the base comprises a channel.

In various embodiments, the base comprises a rectangular shape.

In various embodiments, the base comprises a square shape.

In various embodiments, the system further comprises an enclosure coupled to the magnetic door.

In various embodiments, the enclosure is sewn to the magnetic door.

In various embodiments, the enclosure is taped to the magnetic door.

In various embodiments, the enclosure comprises a flexible fabric.

In various embodiments, the enclosure comprises a retractable member, the retractable member comprising an adjustable inner width.

In various embodiments, the base comprises a flange comprising a seat and further comprises: an enclosure having an opening constructed and arranged to be secured at the seat; and a coupling mechanism that secures the enclosure to the seat.

In various embodiments, the coupling mechanism comprises a hose clamp.

In various embodiments, the system further comprises an enclosure, the enclosure comprising: a first end coupled to the base; and a second end comprising a retractable member, the retractable member comprising an adjustable inner width.

In various embodiments, the magnetic door comprises a material selected from a durable material, a ruggedized nylon material, a nylon taffeta, a rip-stop material, a synthetic material, a natural fabric material, a plastic material.

In various embodiments, the first and second magnets comprise an elongated body having a north pole and a south pole.

In various embodiments, the first and second magnets each comprise a plurality of magnets positioned along the left or right seam.

In various embodiments, the left and right seams comprise corresponding magnets at corresponding vertical positions and wherein north and south poles of the corresponding magnets are configured to be of opposite polarity so that the corresponding magnets attract each other.

In various embodiments, the attachment mechanism comprises a plurality of attachment mechanisms.

In various embodiments, the attachment mechanism comprises a first member and a second member.

In various embodiments, the first member is positioned at the curtain and the second member is positioned between the first member and the magnetic door.

In various embodiments, the first member comprises duct tape and the second member comprises double-sided tape.

In various embodiments, the attachment mechanism comprises double-sided tape.

In various embodiments, the attachment mechanism secures the magnetic door directly to the curtain.

In various embodiments, the attachment mechanism removably secures the magnetic door to the curtain.

In various embodiments, the magnetic door is supported exclusively by the curtain and the attachment mechanism.

In various embodiments, the system further comprising a curtain, wherein the attachment mechanism configured to couple the magnetic door to the curtain.

In various embodiments, the opening is off-center about a width of the magnetic door such that a width of one of the left side and the right side has a greater width than the other of the left side and the right side.

In various embodiments, the opening is positioned at a center of a width of the magnetic door such that a width of the left side is substantially the same as a width of the right side.

### BRIEF DESCRIPTION OF THE DRAWINGS

The foregoing and other features and advantages of the inventive concepts will be apparent from the more particular description of embodiments of the inventive concepts, as illustrated in the accompanying drawings in which like reference characters refer to the same parts throughout the different views. The drawings are not necessarily to scale, emphasis instead being placed upon illustrating the principles of the inventive concepts.

FIG. 1A is a perspective view of an embodiment of a magnetic door, in accordance with aspects of inventive concepts herein.

FIG. 1B is a front view of an embodiment of an arrangement of magnets at seams of a magnetic door, in accordance with aspects of inventive concepts herein.

FIG. 1C is a front view of an embodiment of an arrangement of magnets at seams of a magnetic door, in accordance with aspects of inventive concepts herein.

FIG. 2 is a front view of an embodiment of the magnetic door of FIG. 1A, in accordance with aspects of inventive concepts herein.

FIG. 3 is a rear view of an embodiment of the magnetic door of FIG. 1A, in accordance with aspects of inventive concepts herein.

FIG. 4 is a left view of an embodiment of the magnetic door of FIG. 1A, in accordance with aspects of inventive concepts herein.

FIG. 5 is a right view of an embodiment of the magnetic door of FIG. 1A, in accordance with aspects of inventive concepts herein.

FIG. 6 is a top view of an embodiment of the magnetic door of FIG. 1A, in accordance with aspects of inventive concepts herein.

FIG. 7 is a bottom view of an embodiment of the magnetic door of FIG. 1A, in accordance with aspects of inventive concepts herein.

FIG. 8 is a perspective view of an embodiment of the magnetic door of FIG. 1A coupled to a curtain, in accordance with aspects of inventive concepts herein.

FIGS. 9A-B illustrate perspective view and an exploded view, respectively, of an embodiment of a roll of double-sided tape of a type that can be included with a magnetic door system and/or the magnetic door kit, in accordance with aspects of inventive concepts herein.

FIG. 10A is a front view of an embodiment of a magnetic door knife, in accordance with aspects of inventive concepts herein.

FIG. 10B is a perspective view of an embodiment of a magnetic door system packaged as a kit, in accordance with aspects of inventive concepts herein.

FIGS. 11A-C illustrate a user installing an embodiment of the magnetic door of FIG. 8, in accordance with aspects of inventive concepts herein.

FIG. 12 is a perspective view of an embodiment of a magnetic door coupled to a door frame, in accordance with aspects of inventive concepts herein.

FIG. 13 is a perspective view of an embodiment of a magnetic door with an aperture, in accordance with aspects of inventive concepts herein.

FIG. 14A is a perspective view of an embodiment of a magnetic door with an aperture, in accordance with aspects of inventive concepts herein.

FIG. 14B illustrates alternative embodiments of a base for an air duct, in accordance with aspects of inventive concepts herein.

FIG. 15 is a perspective view of an embodiment of a flexible air duct passing through the magnetic door of FIG. 13, in accordance with aspects of inventive concepts herein.

FIG. 16 is a perspective view of an embodiment of an enclosure illustrating the tightening of a distal end of the enclosure about an outer surface of the body of the flexible air duct using the retractable member, in accordance with aspects of inventive concepts herein.

FIG. 17 is a perspective view of a resulting installation of the flexible air duct, in accordance with aspects of inventive concepts herein.

FIG. 18 is a perspective view of an embodiment of an enclosure coupled to a base for an air duct, in accordance with aspects of inventive concepts herein.

FIG. 19 is a perspective view of an embodiment of an air duct and an enclosure coupled to a base for an air duct, in accordance with aspects of inventive concepts herein.

FIG. 20 is a perspective view of an embodiment of an air duct and an enclosure coupled to the magnetic door, in accordance with aspects of inventive concepts herein.

FIG. 21 is a perspective view of an embodiment of a magnetic door with an aperture, in accordance with aspects of inventive concepts herein.

### DETAILED DESCRIPTION OF EMBODIMENTS

Various example embodiments will be described more fully hereinafter with reference to the accompanying drawings, in which some example embodiments are shown. The present inventive concepts may, however, be embodied in many different forms and should not be construed as limited to the example embodiments set forth herein.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concepts.

Spatially relative terms, such as “beneath,” “below,” “lower,” “above,” “upper” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly. A first element may be said to be “transverse” to a second element if the first element has a direction of extension that is not parallel to the direction of extension of the second element.

The terminology used herein is for the purpose of describing particular example embodiments only and is not intended to be limiting of the present inventive concepts. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in such shapes.

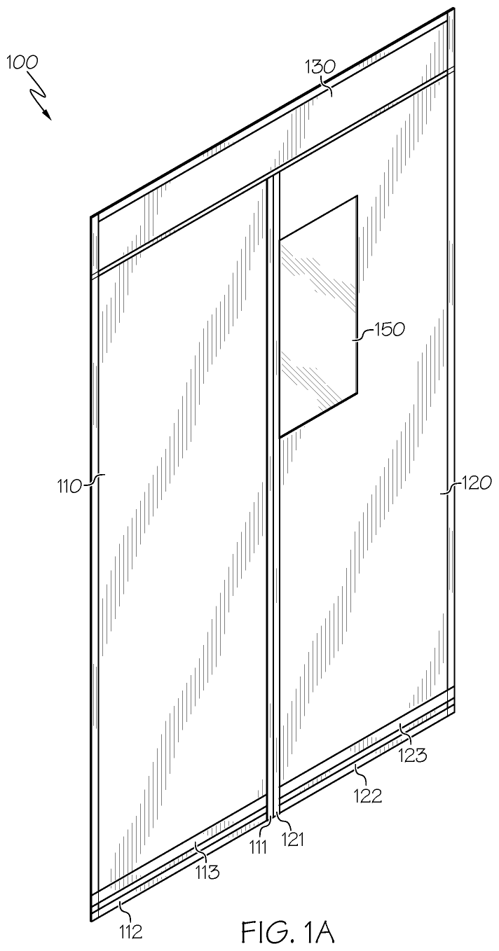

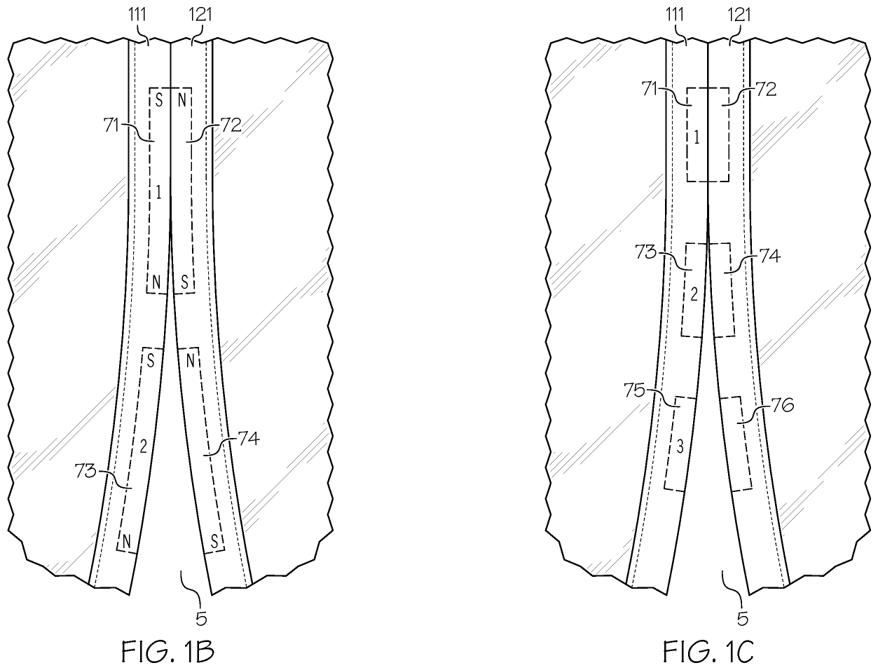

FIG. 1A is a perspective view of an embodiment of a magnetic door 100, in accordance with aspects of inventive concepts herein. In some embodiments, such as the one shown in FIG. 1A, the magnetic doorway 100 comprises a first portion 110, a second portion 120, and a third portion 130. In some embodiments, such as the one shown in FIG. 1A, the first portion 110 and the second portion 120 can be removably coupled to each other such that an opening 5 exists between them (see FIG. 8). In the embodiment shown in FIG. 1A, the magnetic door 100 comprises one opening 5. In alternative embodiments, the magnetic door 100 may comprise more than one opening.

In the embodiment shown in FIG. 1A, the magnetic door 100 has a rectangular shape. In alternative embodiments, the magnetic entryway 100 comprise alternative shapes, including, but not limited to, a circle, square, triangle, or any such suitable polygon or any combinations thereof.

In the embodiment of FIG. 1A, the magnetic door 100 comprises a first seam 111 at an inner edge of the first portion 110 and a second seam 121 at an inner edge of the second portion 120. In some embodiments, each of the first and second seams 111, 121 comprises a plurality of elongated magnets. In some embodiments, the elongated magnets are cylindrical in shape, with a circular cross-section. In other embodiments, the elongated magnets comprise bars that have a rectangular or square cross-section. In various embodiments, the magnets comprise permanent magnets. In some embodiments, the magnets comprise a material type of one or more of ferromagnetic material, a metal, alloy or composite material that exhibits magnetic properties, or other suitable magnetic material.

FIG. 1B is a front view of an embodiment of an arrangement of magnets at the seams 111, 121 of a magnetic door 100, in accordance with aspects of inventive concepts herein. In some embodiments, the elongated magnets are positioned along the seams 111, 121 so that a first magnet 71 in the first seam 111 is positioned at a vertical position opposite a second magnet 72 of the second seam 121, as shown in FIG. 1B and FIG. 1C. In particular each first magnet 71 of the first seam 111 and corresponding second magnet 72 of the second seam 121 may be positioned so that their respective north N and south S poles are opposite, and therefore, they attract each other as shown. In this manner, the magnetic fields of the neighboring magnets may be naturally attractive to each other, biasing the magnetic door 100 to be naturally biased to be in a closed state. In some embodiments, the magnets may be secured into defined vertical positions, for example by horizontal seam stitching to fix their respective vertical positions, and thus ensure long-term attraction of the first and second seams 111, 121. In some embodiments, the magnets may be positioned in a sleeve portion of the seams 111, 121. In another embodiment, one of the seams of seams 111 and 121 can include magnets and the other seam of the seams 111 and 121 can include elements of magnetically attractive material, such as metal elements.

In the embodiment shown in FIG. 1B the first magnet 71 is oriented with a south pole above a north pole. In alternative embodiments, the first magnet 71 is oriented with a north pole above a south pole.

In the embodiment shown in FIG. 1B the second magnet 72 is oriented with a south pole above a north pole. In alternative embodiments, the second magnet 72 is oriented with a north pole above a south pole.

In some embodiments, the magnets 71 and 72 comprise discrete elements, rather than bars. In some embodiments, the discrete elements can comprise spherical elements, round elements, or discrete elements of other geometries. The individual magnets 71 and 72 can be positioned to be separate from each other in a vertical direction, and can be selected so that corresponding neighboring magnets on the opposite seam 111, 121 are attractive. In another embodiment, one of the seams 111, 121 can include magnets and the other seam 121, 111 can include elements of magnetically attractive material, such as metal elements.

In alternative embodiments, the magnets may be configured in a manner similar or identical to configurations described in PCT Publication No. WO 2017/117042.

In some embodiments, such as the one shown in FIG. 1B, the first seam 111 of the magnetic entryway 100 further comprises a third magnet 73. In the embodiment shown in FIG. 1B, the second seam 121 of the magnetic door 100 further comprises a fourth magnet 74. In some embodiments, the third 73 and fourth 74 magnets are constructed and arranged to magnetically couple.

In some embodiments, the magnitude of the magnetic force between the third magnet 73 and the fourth magnet 74 is greater than the magnitude of the magnetic force between the first magnet 71 and the second magnet 72. In some embodiments, the magnitude of the magnetic force between the third magnet 73 and the fourth magnet 74 is weaker than the magnitude of the magnetic force between the first magnet 71 and the second magnet 72. The magnets with the weaker force between them may be easier to separate, facilitating easier seam separation. The magnets with the stronger force between them may recouple more easily, facilitating easier seam recoupling. In some embodiments, any of the patterns of magnet pairs repeats along the length of the magnetic door 100.

In the embodiment shown in FIG. 1B, the first magnet 71 comprises a first length, the second magnet 72 comprises a second length, the third magnet 73 comprises a third length, and the fourth magnet 74 comprises a fourth length. In some embodiments, such as the embodiment in FIG. 1B, the magnitude of the first length is the same as the magnitude of the second length. In some embodiments, such as the embodiment in FIG. 1B, the magnitude of the third length is the same as the magnitude of the fourth length. In some embodiments, the first length and the second length are greater in magnitude than the third length and the fourth length.

In some embodiments, the magnet pairs comprising longer lengths are the magnet pairs with a weaker magnetic force between them. In some embodiments, the magnet pairs comprising longer lengths are the magnet pairs with a stronger magnetic force between them.

In the embodiment shown in FIG. 1B the third magnet 73 is oriented with a south pole above a north pole. In alternative embodiments, the third magnet 73 is oriented with a north pole above a south pole.

In the embodiment shown in FIG. 1B the fourth magnet 74 is oriented with a south pole above a north pole. In alternative embodiments, the fourth magnet 74 is oriented with a north pole above a south pole.

In the embodiment shown in FIG. 1B, the first magnet 71 and the second magnet 72 form a first pair. In the embodiments shown in FIG. 1B, the third magnet 73 and the fourth magnet 74 form a second pair.

In some embodiments, the first magnet 71 and the third magnet 73 are spaced apart in a substantially vertical direction, that is, by a vertical gap. In some embodiments, the first magnet 71 abuts the third magnet 73.

In some embodiments, the second magnet 72 and the fourth magnet 74 are spaced apart in a substantially vertical direction, that is, by a vertical gap. In some embodiments, the second magnet 72 abuts the fourth magnet 74.

Although FIG. 1B shows two pairs of magnets, the embodiment of FIG. 1A may include any number of magnet pairs and one or more of the magnet pairs may include the characteristics described in connection with FIG. 1B.

FIG. 1C is a front view of an embodiment of an arrangement of magnets at the seams 111, 121 of a magnetic door 100, in accordance with aspects of inventive concepts herein. In some embodiments, such as the one shown in FIG. 1C, different types of magnets 71/72, 73/74, 75/76 are used, with the magnitude of the force between the first set of magnets 71 and 72 being greater than the magnitude of the force between the second set of magnets 73, 74 and the magnitude of the force between the third set of magnets 75, 76. The magnitude of the force between the second set of magnets 73, 74 is greater than and the magnitude of the force between the third set of magnets 75, 76. In alternative embodiments, the arrangement of the magnet pairs differs. In some cases, the magnets with the greatest force between them are below those with a weaker force between them. In some embodiments, any of the patterns of magnet pairs repeats along the length of the magnetic door 100.

In some embodiments, the magnetic pairs may comprise different lengths from each other.

In some embodiments, the third magnet 73 and a fifth magnet 75 are spaced apart in a substantially vertical direction, that is, by a vertical gap. In some embodiments, the third magnet 73 abuts the fifth magnet 75.

In some embodiments, the fourth magnet 74 and a sixth magnet 76 are spaced apart in a substantially vertical direction, that is, by a vertical gap. In some embodiments, the fourth magnet 74 abuts the sixth magnet 76.

Although FIG. 1C shows three pairs of magnets, the embodiment of FIG. 1A may include any number of magnet pairs and one or more of the magnet pairs may include the characteristics described in connection with FIG. 1C.

In some embodiments, the first portion 110 comprises a first bottom seam 112. In some embodiments, the first portion 110 comprises a second bottom seam 113. In some embodiments, the second portion 120 comprises a first bottom seam 122. In some embodiments, the second portion 120 comprises a second bottom seam 123.

In some embodiments, magnets positioned at opposite seams 111, 121 have opposite polarities creating a magnetic force between the left seam and the right seam so at a resting position the magnetic force is strong enough to retain the seams 111, 121 so that they remain positioned next to each other. At the same time, the magnets can be selected to be of a weak enough strength so that their magnetic attraction force is sufficiently weak to allow an operator to break the attractive seam and readily walk through the seam without much constraint. In some embodiments the magnets are selected to be of a strength so that a simple elbow nudge would create a large enough force to break the magnetic force between the seams 111, 121.

In some embodiments, the magnetic door automatically closes after a user walks through. As a result of the positioning of the magnets, and, as a result of the proximity of the magnets when the magnetic door 100 naturally drapes back into position in the opening 5 as a result of gravity and as a result of the magnetic attraction, the left and right seam portions 111, 112 re-locate with respect to each other and automatically close. Registration of the left and right seam portions together, that is, the reconnection of the first seam 111 and the second seam 112 after a user walks through the opening, can be further ensured by a number of factors including: relative placement of the magnets in the left and right seam portions 111, 121, placement of weights at a bottom portion of the magnetic door 100 at its lower end, the tautness of the mounting of the magnetic door 100, the material of the magnetic door 100, the weight of the magnetic door 100, and other factors, and combinations of these factors. In this manner, the magnetic door 100 operates to re-couple, automatically preparing the magnetic door 100 for the next operator to pass through.

In some embodiments, a lower region of the first portion 110 comprises a weight that is greater than an upper region of the first portion 110 to ensure or improve registration of the first 111 and second seams 121 together by applying longitudinal tension to the body of the magnetic door 100. In some embodiments, a lower region of the second portion 120 comprises a weight that is greater than an upper region of the second portion 120 to ensure or improve registration of the first 111 and second seams 121 by applying longitudinal tension to the body of the magnetic door 100.

In some embodiments, an upper region of the first portion 110 comprises a weight that is greater than a lower region of the first portion 110 to ensure or improve registration of the first 111 and second seams 121 together by applying longitudinal tension to the body of the magnetic door 100. In some embodiments, an upper region of the second portion 120 comprises a weight that is greater than a lower region of the second portion 120 to ensure or improve registration of the first 111 and second seams 121 together by applying longitudinal tension to the body of the magnetic door 100.

In some embodiments, such as the one shown in FIG. 1A, the magnetic door 100 comprises a third portion 130. In the embodiments shown in FIG. 1A, the third portion 130 extends horizontally across the top of the magnetic door 100. That is, the third portion 130 extends along upper portions of the first portion 110 and the second portion 120. In some embodiments, a seam extends along the upper portions of the first portion 110 and the second portion 120. In some embodiments, no seam extends along the upper portions of the first portion 110 and the second portion 120. The third portion 130 provides space in the magnetic door 100 between the top of the opening 5 and a top of the magnetic door 100. In some embodiments, the third portion 130 comprises a sleeve. In some embodiments, the sleeve comprises one or more characteristics identical or similar to those described in connection with WO 2017/117042, which is incorporated by reference in its entirety herein. In some embodiments, the sleeve comprises one or more characteristics identical or similar to those described in connection with WO 2020/118277, which is incorporated by reference in its entirety herein.

In some embodiments, such as the one shown in FIG. 1A, the magnetic door 100 comprises at least one window 150. In alternative embodiments, the magnetic door 100 does not comprise any windows. In alternative embodiments, the magnetic door 100 comprises more than one window 150.

In the embodiment shown in FIG. 1A, the second portion 120 comprises a window 150. In alternative embodiments, the at least one window 150 is on the first portion 110. The position of the window 150 is not limited to the position illustrated in FIG. 1A. That is, the window may be positioned along the first and/or second portions 110 and 120 at any position along the length thereof. In addition, the window 150 may comprise a plurality of windows on one of the first portion 110 and second portion 120 or both of the first portion 110 and second portion 120. In some embodiments, such as the one in FIG. 1A, the window 150 comprises a width that is less than a quarter of a width of the magnetic door 100. In alternative embodiments, the window 150 comprises a width that is greater than a quarter of a width of the magnetic door 100.

In some embodiments, such as the one in FIG. 1A, the window 150 does not extend to an outer edge of the magnetic door 100. In alternative embodiments, at least one window 150 extends to an outer edge of the magnetic door 100.

In the embodiment shown in FIG. 1A, the window 150 is not centered about a center width of the second portion 120. In alternative embodiments, the window 150 is centered about a center width of the first 110 and/or second portion 120.

In the embodiment shown in FIG. 1A, the window 150 comprises a rectangular shape. In alternative embodiments, the window 150 comprises an alternative shape, including a circle, square, triangle, or any such suitable polygon or any combinations thereof.

In the embodiment of FIG. 1A, the window 150 is elongated along a vertical axis. In alternative embodiments, one or more windows 150 are elongated along a horizontal axis. In alternative embodiments, one or more windows 150 are elongated in a direction that has both a vertical and a horizontal component, that is, for example, a diagonal direction.

In the embodiment shown in FIG. 1A, the window 150 comprises a material that is transparent to visible light. In alternative embodiments, the window 150 comprises a filter configured such that it prevents or substantially reduces the transmission of electromagnetic radiation from a predetermined portion of the electromagnetic spectrum.

In the embodiment shown in FIG. 1A, the magnetic door 100 comprises flame retardant material. In alternative embodiments, the magnetic door 100 does not comprise flame retardant material.

In some embodiments, the magnetic door 100 comprises thermal insulation to reduce the transfer of heat from one region to another.

In some embodiments, the magnetic door 100 comprises acoustic panels to reduce the transmission of sound waves from one region to another.

In some embodiments, the magnetic door 100 is, for example, 87 inches long; however, the present inventive concepts are not limited thereto. In some embodiments, the magnetic door 100 is 48 inches wide; however, the present inventive concepts are not limited thereto.

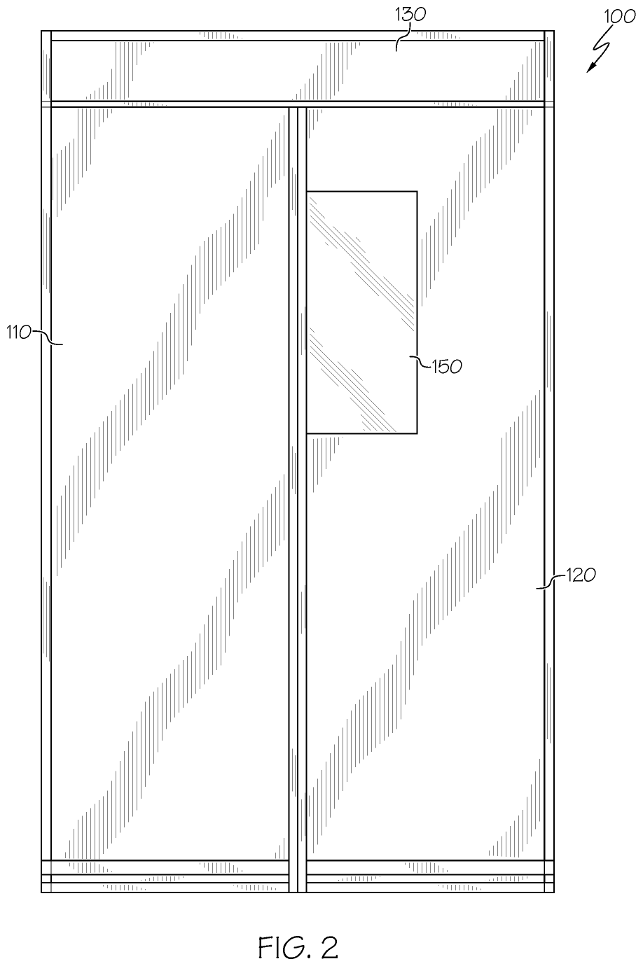

FIG. 2 is a front view of an embodiment of a magnetic door 100 of FIG. 1A, in accordance with aspects of inventive concepts herein.

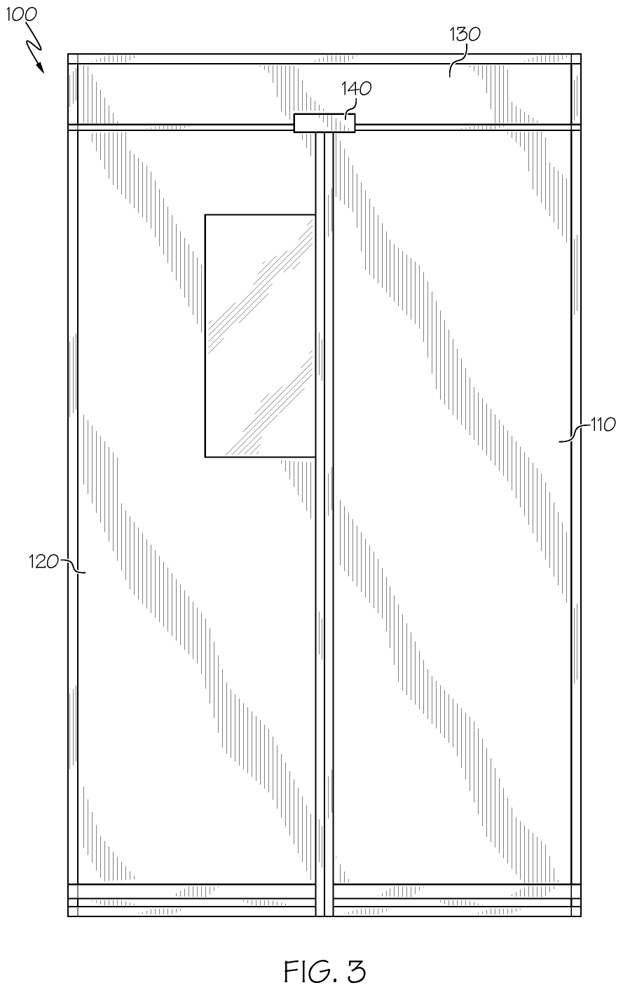

FIG. 3 is a rear view of an embodiment of a magnetic door 100 of FIG. 1A, in accordance with aspects of inventive concepts herein. In some embodiments, such as the one in FIG. 3, the magnetic door 100 comprises a support mechanism 140. In some embodiments, such as the one shown in FIG. 3, the third portion 130 comprises a support mechanism 140.

In some embodiments, the support mechanism 140 ensures that the magnetic door 100 experiences upward tension at a center region thereof, ensuring proper self-closing action of the left and right seams 111,121, for example, proper registration and magnetic coupling of the magnets positioned at the left and right seams 111,121, as described herein.

In some embodiments the support mechanism 140 is constructed and arranged to allow the magnetic door 100 to support a weight without substantial deformation. In some embodiments, the support mechanism 140 is sewn to the magnetic door 100. In alternative embodiments, the support mechanism 140 is bonded to the magnet door 100 using another technique. In some embodiments, the support mechanism 140 is not coupled to the magnetic door 100 and extends from a neighboring surface. In some embodiments, the support mechanism 140 extends from the magnetic door 100.

In the embodiment shown in FIG. 3, the support mechanism 140 is a piece of tape; however, the present inventive concepts are not limited thereto.

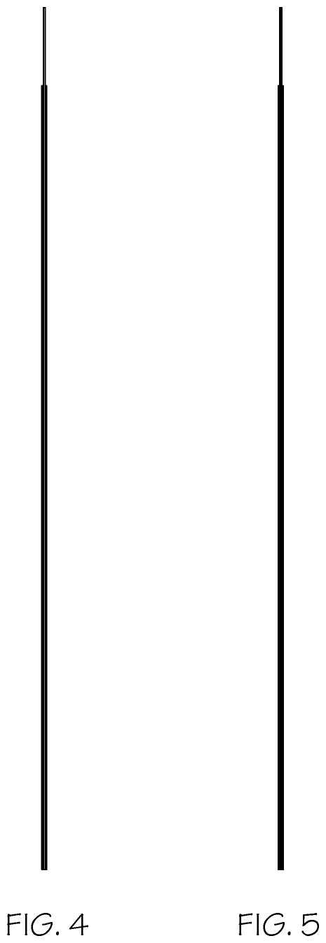

FIG. 4 is a left view of an embodiment of a magnetic door 100 of FIG. 1A, in accordance with aspects of inventive concepts herein.

FIG. 5 is a right view of an embodiment of a magnetic door 100 of FIG. 1A, in accordance with aspects of inventive concepts herein.

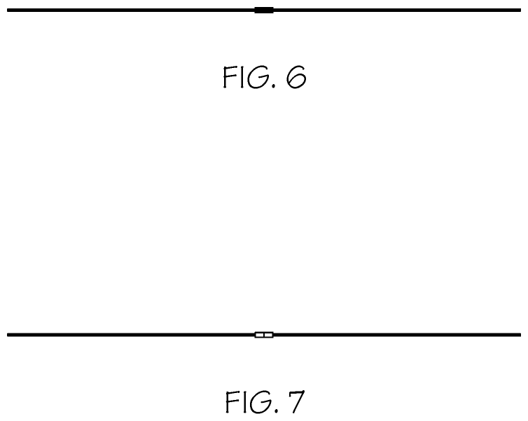

FIG. 6 is a top view of an embodiment of a magnetic door 100 of FIG. 1A, in accordance with aspects of inventive concepts herein.

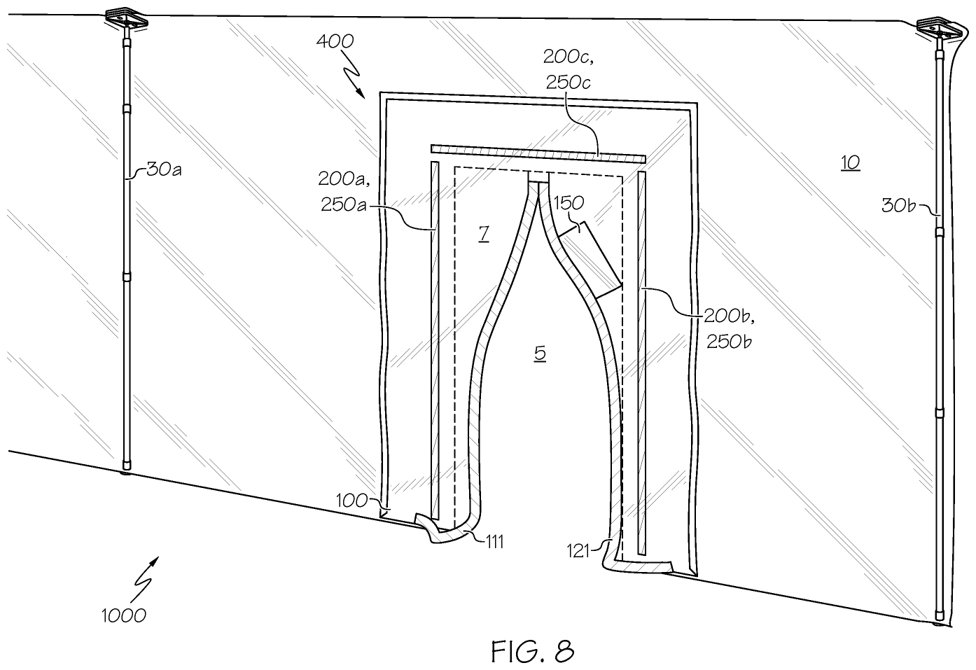

FIG. 7 is a bottom view of an embodiment of a magnetic door 100 of FIG. 1A, in accordance with aspects of inventive concepts herein.

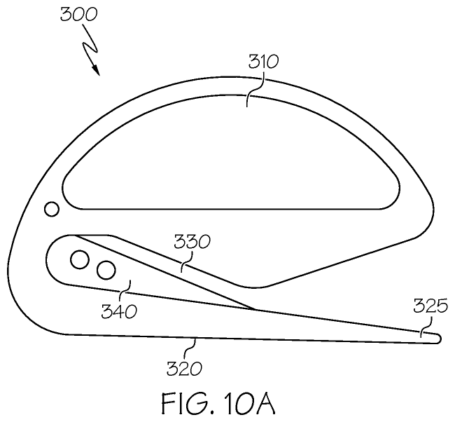

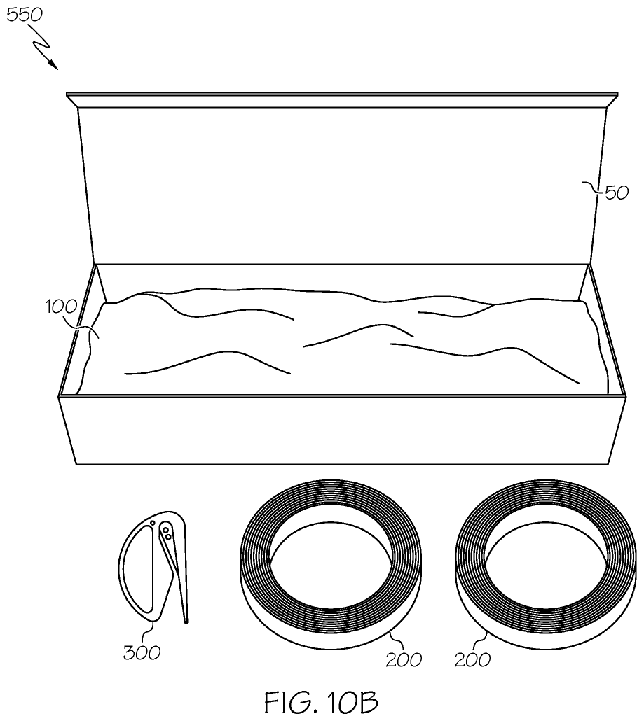

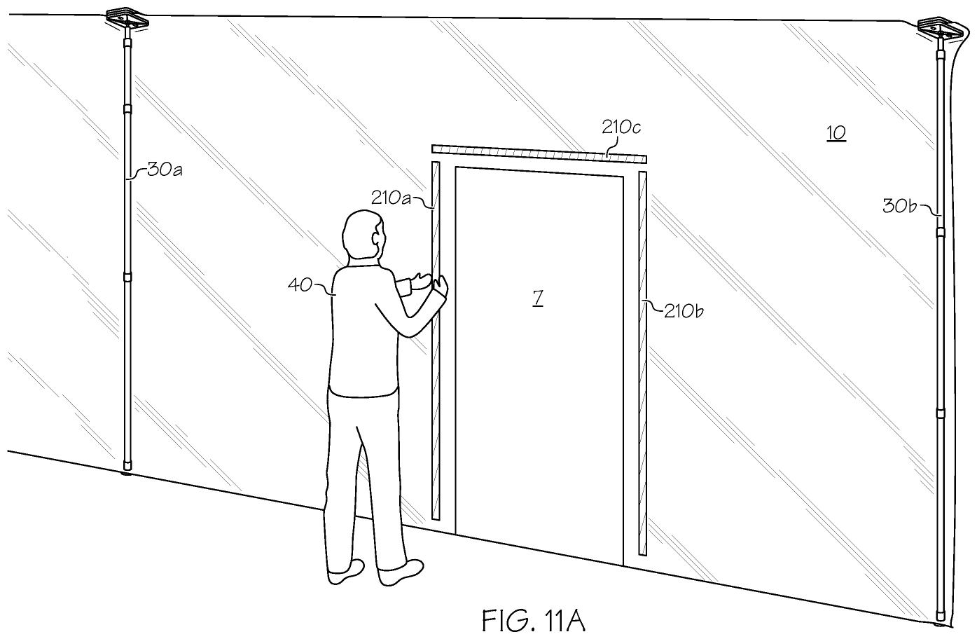

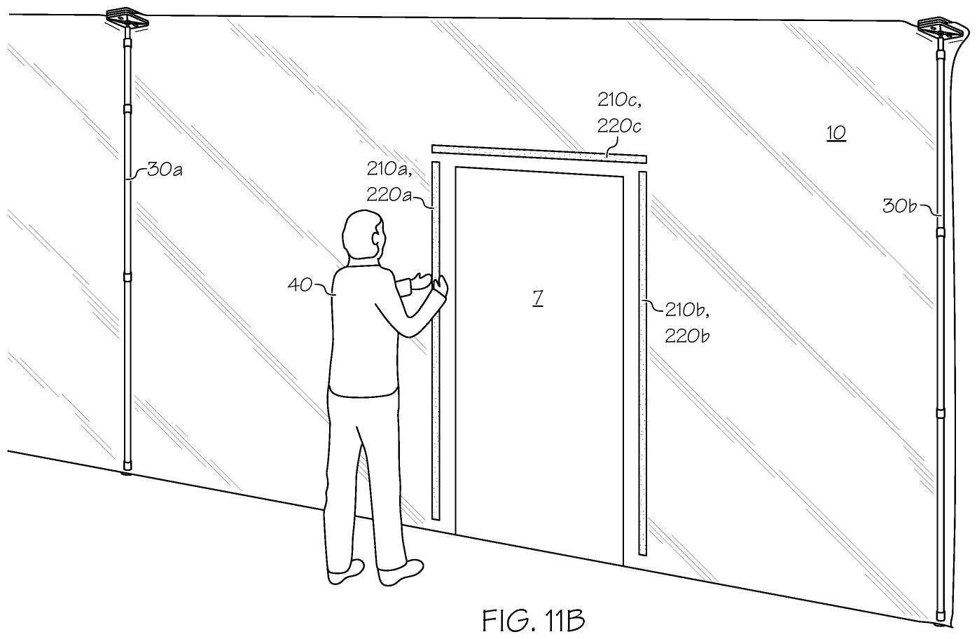

FIG. 8 is a perspective view of an embodiment of the magnetic door 100 of FIG. 1A coupled to a curtain 10, in accordance with aspects of inventive concepts herein. In some embodiments, a magnetic door 100 is a component of a magnetic door system 400 or a kit for a magnetic door system. In some embodiments, the magnetic door system 400 comprises a magnetic door 100 and an attachment mechanism 200. In some embodiments, the magnetic door system 400 also comprises a knife 300, as seen in FIGS. 10A and 10B. In some embodiments, the knife 300 is configured for cutting a curtain 10. In alternative embodiments, the knife 300 is any tool configured for cutting any surface. In some embodiments, as illustrated in FIG. 10B, a magnetic door kit 550 comprises the magnetic door 100, at least one attachment mechanism 200, that is, the at least one attachment mechanism comprising at least one roll of double-sided tape, and the knife 300. In some embodiments, the magnetic door kit 550 further comprises a roll of tape, for example, a roll of duct tape. In some embodiments, the magnetic door kit 550 further comprises the curtain 10. In some embodiments, the magnetic door kit further comprises the curtain 10 and at least one pole 30a, 30b.

In some embodiments, at least one magnetic door 100 has dimensions of 9½ feet by 9½ feet; however, the present inventive concepts are not limited thereto.

In some embodiments, a partition system 1000 is assembled by first mounting a pole 30a between first and second surfaces, for example between a floor and a ceiling of a building. In some embodiments, a curtain 10 is coupled to the pole 30a, and the pole 30a operates to create vertical tension in the curtain 10 between the floor and the ceiling. Neighboring poles 30b, etc., likewise mounted, operate to create horizontal tension in the curtain 10. In this manner, the pole system 1000 creates vertical and horizontal tension in the curtain 10, which tension is transferred to similarly tension the magnetic door 100. In some embodiments, such as the embodiment shown in FIG. 8, one or more spring-biased pole mounts 30a, 30b secure a curtain 10 or drape material, such as plastic, cloth, and the like, to form a temporary partition.

In some embodiments, the curtain 10 comprises one or more curtains. In embodiments in which the curtain 10 comprises one or more curtains, the one or more curtains are coupled together using different attachment mechanisms, including, but not limited to one or more zippers. In embodiments in which the curtain 10 comprises one or more curtains, the curtain may have characteristics similar or identical to curtains described in connection with U.S. Pat. No. 9,657,514 and the other patents incorporated herein by reference.

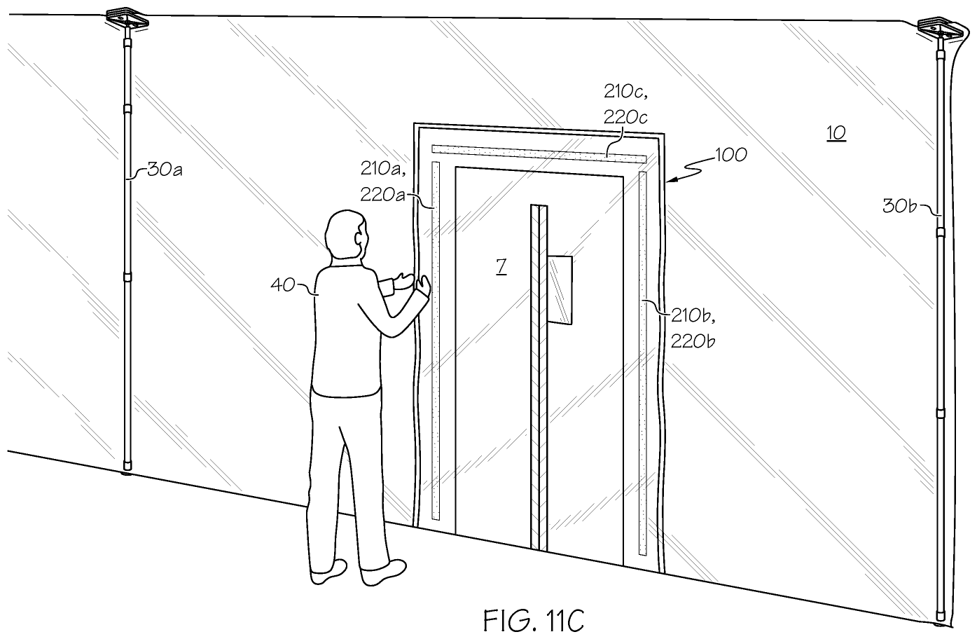

In some embodiments, such as the one shown in FIG. 8, the curtain 10 comprises an entryway opening 7. The entryway opening 7 may be formed by cutting and removing a portion of the curtain 10 or by some other mechanism (as seen in FIGS. 11A-11C). In some embodiments, the entryway opening 7 is created using the knife 300. In some embodiments, the knife 300 comprises one or more of the characteristics of a cutter of U.S. Pat. No. 7,743,512, which is incorporated herein by reference in its entirety. Alternatively, the knife 300 can comprise the knife as illustrated in FIGS. 10A and 10B. Alternatively, the knife 300 may be any cutting means.

In some embodiments, the magnetic door 100 is mounted such that it obstructs the entryway opening 7 when the first seam 111 of the magnetic door 100 is coupled to the second seam 121 of the magnetic door. In some configurations, such as the one shown in FIG. 8, at least a portion of the first seam 111 and the second seam 121 are decoupled, creating an opening 5. If the opening 5 created between the first seam 111 and the second seam 121 overlaps with the entryway opening 7, a user may pass from one side of the curtain 10 to another side of the curtain 10.

In some embodiments, such as the one shown in FIG. 8, the magnetic door 100 comprises a vertical height that is less than a vertical height of the neighboring curtain 10. In alternative embodiments, the magnetic door 100 comprises a vertical height that is substantially the same as a vertical height of the neighboring curtain 10. In alternative embodiments, the magnetic door 100 comprises a vertical height that is greater than a vertical height of the neighboring curtain 10.

In some embodiments, such as the one shown in FIG. 8, the magnetic door 100 is coupled to the curtain 10 at one or more attachment regions 250 a-c using one or more corresponding attachment mechanisms 200 a-c.

In the embodiment shown in FIG. 8, there are three attachment mechanisms 200 a-c. In alternative embodiments, there are a different number of attachment mechanisms and attachment regions.

In the embodiment shown in FIG. 8, the attachment mechanisms 200a-c are rectangular in shape. In alternative embodiments, the attachment mechanisms may take a different shape including, but not limited to, a square, triangle, or any such polygon or any combinations thereof. In some embodiments, different attachment mechanisms in the same embodiment have different shapes.

In the embodiment shown in FIG. 8, the attachment mechanisms 200 a-c are located on the sides of the magnetic door 100 and above the magnetic door 100. In alternative embodiments, the attachment mechanisms 200 a-c are located at different positions, such as just above the magnetic door 100 or just on one or both sides of the magnetic door 100.

In the embodiment shown in FIG. 8, there are two attachment mechanisms 200a, 200b on each side of the magnetic door 100. In alternative embodiments there are a different number of attachment mechanisms on each side of the magnetic door 100. For example, in some embodiments, there is one attachment mechanism 200 on one or both sides of the magnetic door 100. In alternative embodiments, there is more than two attachment mechanisms 200 on one or both sides of the magnetic door 100.

In the embodiment shown in FIG. 8, one attachment mechanism 200c is provided above the magnetic door 100. In alternative embodiments, a plurality of attachment mechanisms are provided above the magnetic door 100. In alternative embodiments, no attachment mechanism 200c is provided above the magnetic door 100. In some embodiments, attachment mechanisms 200 a-c extend near at least a portion of the perimeter of the magnetic door 100. The arrangement of the attachment mechanisms 200 are not limited by the configurations shown. In alternative embodiments, one or more of the one or more attachment mechanisms 200 are arranged differently.

In some embodiments, such as the one shown in FIG. 8, the one or more attachment mechanisms 200 a-c extend between the magnetic door 100 and the neighboring surface (in FIG. 8, the curtain 10). That is, in some embodiments, the attachment mechanism is positioned between a surface of the curtain 10 and the magnetic door 100. In alternative embodiments, one or more of the one or more attachment mechanisms 200 do not extend between the magnetic door 100 and the neighboring surface, but rather press the magnetic door 100 against the neighboring surface. For example, in some embodiments, the attachment mechanism comprises tape, and the tape may extend around at least a portion of the perimeter of the magnetic door 100. In such embodiments, the tape is coupled to both a surface of the magnetic door 100 and the neighboring surface of, for example, the curtain 10, and the tape is configured to press the magnetic door 100 against the neighboring surface of, for example, the curtain.

In some embodiments, one or more attachment mechanisms 200 a-b are aligned such that lowest vertical height of the attachment mechanism 200 a-b is at the same vertical height as the bottom of the magnetic door 100. In some embodiments, one or more attachment mechanisms 200 a-b are aligned such that the highest vertical height of the attachment mechanism 200 a-b is at the same vertical height as the top of the magnetic door 100.

In some embodiments, such as the one shown in FIG. 8, the attachment mechanism 200 a-c comprises at least one type of tape. In some embodiments, one or more attachment mechanisms 200 a-c comprise a plurality of tape strips. In some embodiments, the one or more attachment mechanisms 200 a-c comprise double-sided tape. In some embodiments, the attachment mechanism 200 comprises a hook and loop mechanism. In alternative embodiments, the attachment mechanism 200 comprises one or more magnets. In alternative embodiments, the attachment mechanism 200 comprises one or more hooks. In alternative embodiments, the attachment mechanism 200 comprises one or more pin and slot connectors. In alternative embodiments, the attachment mechanism 200 comprises a clamp. In some embodiments, the attachment mechanism 200 comprises one or more staples. In alternative embodiments, the attachment mechanism 200 comprises glue, and/or any mechanism suitable for connecting two objects.

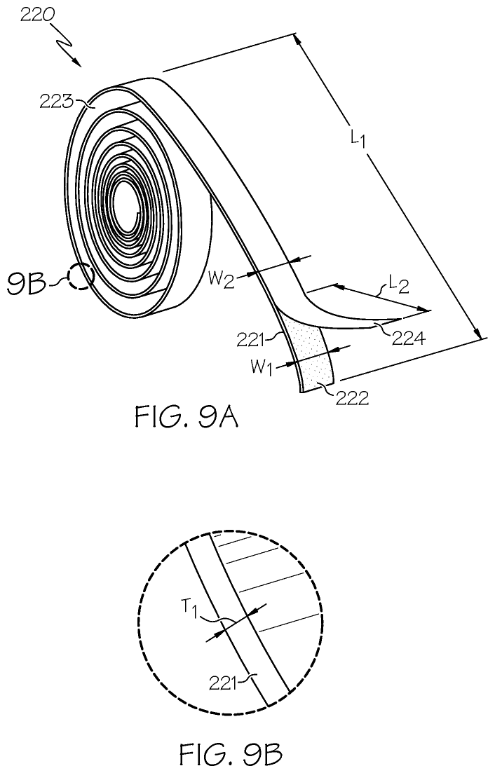

In some embodiments, such as the one shown in FIGS. 9A, 9B and 11A-11C, the one or more of the one or more attachment mechanisms 200 a-c comprises a first member 210 a-c and a second member 220 a-c. In some embodiments, the first member 210 is configured to couple to the surface to which the magnetic door 100 is to be mounted, for example, the curtain 10. In some embodiments, the second member 220 is configured to couple to the first member 210 and a back surface of the magnetic door 100. In some embodiments, the position of each first member 210 is aligned with the position of a corresponding second member 220 such that the magnetic door 100 is mounted in the desired manner.

In some embodiments, such as the one shown in FIGS. 11A-C, the first member 210 comprises tape. In some embodiments, the first member 210 comprises tape with an adhesive on a side facing the neighboring surface (for example, curtain, door frame, other object). In the embodiment shown in FIGS. 11A-11C, the first member 210 comprises duct tape. In alternative embodiments, the first member 210 comprises a different type of tape. In alternative embodiments, the first member 210 comprises at least a portion of a hook and loop mechanism. In alternative embodiments, the first member 210 comprises one or more magnets. In alternative embodiments, the first member 210 comprises one or more hooks. In alternative embodiments, the first member 210 comprises at least a portion of one or more pin and slot connectors. In alternative embodiments, the first member 210 comprises a clamp. In some embodiments, the first member 210 comprises one or more staples. In alternative embodiments, the first member 210 comprises glue, and/or any mechanism suitable for connecting two objects. In alternative embodiments, the first member 210 is integral with the curtain 10. In alternative embodiments, the first member 210 is integral with the mounting surface.

In some embodiments, such as the one shown in FIGS. 9A-9B, the second member 220 comprises tape. In some embodiments, the second member 220 comprises double-sided tape with adhesive on both sides. In alternative embodiments, the second member 220 comprises a different type of tape. In alternative embodiments, the second member 220 comprises at least a portion of a hook and loop mechanism. In alternative embodiments, the second member 220 comprises one or more magnets. In alternative embodiments, the second member 220 comprises one or more hooks. In alternative embodiments, the second member 220 comprises at least a portion of one or more pin and slot connectors. In alternative embodiments, the second member 220 comprises a clamp. In some embodiments, the second member 220 comprises one or more staples. In alternative embodiments, the second member 220 comprises glue, and/or any mechanism suitable for connecting two objects.

In some embodiments, such as the embodiment shown in FIG. 8, the second member 220 comprises double-sided tape and the opposing sides of the double-sided tape have different adhesive strengths. In the embodiment shown in FIG. 8, the double-sided tape is applied such that the side with the greater adhesive strength is applied to the back surface of the magnetic door 100. The side of the double-sided tape with less adhesive strength faces away from the magnetic door 100.

In some embodiments, the presence of the first member 210 facilitates better coupling to the mounting surface than might be possible if the second member 220 was directly coupled to mounting surface, in this case, a curtain 10. In some embodiments, because the side of the double-sided tape with the weaker adhesive strength is facing the first member 210, the second member 220 can be decoupled from the first member 210 to allow the user to remove the magnetic door 100.

In the embodiment shown in FIG. 8, the second member 220 comprises double-sided tape and the opposing sides of the double-sided tape comprises different adhesive strengths and, when mounted, the side with the stronger adhesive strength facing the magnetic door 100 and the side with the weaker adhesive strength facing the first member 210. In alternative embodiments, the two sides of the double-sided tape comprise the same adhesive strength. In alternative embodiments, when mounted, the side with the weaker adhesive strength faces the magnetic door 100 and the side with the stronger adhesive strength faces the first member 210.

In some embodiments, the role of the first member 210 and the second member 220 as described in connection with FIGS. 11A-11C is reversed. In such embodiments, the first member 210 may comprise double-sided tape. In such embodiments, the second member 220 may comprise a tape, such as duct tape, with a single side with an adhesive layer. In such embodiments, the double-sided tape is applied to the mounting surface (for example, a curtain, a door frame, etc.) and the duct tape is applied to the back side of the magnetic door 100. In some such embodiments, the double-sided tape comprises two sides with equal adhesive strengths. In some such embodiments, the double-sided tape comprises a side with a greater adhesive strength and that side faces the mounting surface. In some such embodiments, the double-sided tape comprises a side with a greater adhesive strength and that side faces the second member 220.

In some embodiments, one or more of the one or more attachment mechanisms 200 comprises a second member 220 and does not comprise a first member 210. In some such embodiments, the second member 220 comprises double-sided tape. In some such embodiments, the double-sided tape may have two sides with equal adhesive strengths. In some such embodiments, the double-sided tape comprises a side with a greater adhesive strength and that side faces the mounting surface. In some such embodiments, the double-sided tape comprises a side with a greater adhesive strength and that side faces the magnetic door 100.

FIGS. 9A-B show an exploded perspective view of an embodiment of the second member 220 comprising a roll of double-sided tape of a type that can be included with the magnetic door system 400 and/or the magnetic door kit, in accordance with aspects of inventive concepts herein. In other embodiments, the roll of double-sided tape 220 can be provided exclusive of the magnetic door kits disclosed herein, and provided on its own. The roll of double-sided tape 220 can comprise a carrier material 221 having a high-tack adhesive material 222 on a first side of the carrier material 221 and a low-tack adhesive material 223 on a second side of the carrier material 221. The carrier material 221 can comprise any of a number of carrier materials. In some embodiments, the carrier material 221 comprises paper, such as, crepe paper, calendared paper, rope paper, and the like. The carrier material 221 has a thickness T1, which ranges, in some embodiments, between about 0.1 mm to about 0.3 mm. In this manner, the resulting double-sided tape 220 having a paper carrier material may be easily ripped or torn by hand.

In one embodiment, the roll of double-sided tape 220 comprises a single-layer carrier material 221 having a high-tack adhesive material 222 on a first side of the carrier material 221 and a low-tack adhesive material 223 on a second side of the carrier material 221. In other embodiments, the roll of double-sided tape 220 comprises a multi-layer carrier material 221 having a high-tack adhesive material 222 on a first side of a first carrier material 221a and a low-tack adhesive material 223 on a first side of a second carrier material 221b. In this embodiment, the second sides of first and second carrier materials 221a, 221b can be affixed together by an adhesive material or other suitable substrate.

In other embodiments, the carrier material 221 can comprise a polyester film (e.g., Mylar or Melinex), a Polypropylene film, a Polyethylene film, a cloth material, a vinyl film or a combination of the above.

The roll of double-sided tape 220 can further comprise a tape liner 224 that covers the at least one side of the carrier material 221. In some embodiments, the tape liner 224 is positioned on the high-tack adhesive material 222 so that the roll of double-sided tape 220 can be easily unrolled. The tape liner 224 may comprise, in some embodiments, a paper release liner, a plastic release liner, a colored release liner, and/or the like. In one embodiment, a colored release liner is provided such that the release liner is visibly distinguishable from the carrier material. In this manner, the colored release liner can be easily distinguished from the carrier material, allowing for easy removal by an installer. Assuming a paper carrier material and a paper tape liner are used in combination, the double-sided tape may be easily ripped or torn by hand.

The colored release liner can comprise: red-colored release liner, a yellow-colored release liner, a blue-colored release liner, a green-colored release liner, a black-colored release liner, or an orange-colored release liner. In some embodiments, the release liner comprises a color associated with the product seller's trade color.

The carrier material can comprise a white-colored carrier material, a tan-colored carrier material or a grey-colored carrier material. In some embodiments, the carrier material comprises a color associated with the product seller's trade color, and can be different from that of the color of the release liner.

The carrier material 221 and the tape liner 224 have widths W1, W2, respectively, which range, in some embodiments, between about ½ of an inch to about 4 inches in width. In other embodiments, the widths W1, W2 can be less than ½ of an inch or greater than 4 inches in width. Further, the width W1 of the carrier material 221 and the width W2 of the tape liner 224 can be substantially equal in width. The carrier material 221 and the tape liner 224 have lengths L1, L2, respectively, which range, in some embodiments, between about 10 feet and about 50 feet in length. In other embodiments, the lengths L1, L2 can be less than 10 feet or greater than 50 feet in length.

The high-tack adhesive material 222 and the low-tack adhesive material 223 may comprise a rubber adhesive compound. However, the high-tack adhesive material 222 and the low-tack adhesive material 223 may comprise other suitable adhesive compounds. The high-tack adhesive material 222 has a peel adhesion (N/in), which is, in some embodiments, greater than or equal to 20 N/in, preferably about 25 N/in. In other embodiments, the high-tack adhesive material 222 can optionally have a peel adhesion of less than 20 N/in. The low-tack adhesive material 223 has a peel adhesion, which is, in some embodiments, less than or equal to 15 N/in, preferably about 10 N/in. In other embodiments, the low-tack adhesive material 223 can optionally have a peel adhesion of greater than 15 N/in. As such, the low-tack adhesive material 223 allows for the double-sided tape 220 to be removed from an entry way, a window frame, a door frame, or other opening without removing paint or wallpaper thereon or leaving a residue behind.

The first side of the carrier material 221 having the high-tack adhesive material 222 can be adhered to a magnetic door 100, and can withstand a negative or positive pressure differential between partitioned areas. Negative pressure is often created in an enclosed area because an enclosed area with negative pressure will suck air into it when doors or windows are opened. This prevents dust or other debris from escaping through opened doors and windows.

The double-sided tape 220 has a differential adhesive ratio (ratio of peel adhesion of the high-tack adhesive material 222 to the peel adhesion of the low-tack adhesive material 203), which ranges, in some embodiments, between about 4:3 to about 6:1, preferably the differential adhesive ratio is about 5:2.

In some embodiments, the low-tack side of the double-sided tape comprises a UV protectant, which prevents adhesive residue from being left on glass, frame moldings and the like.

FIG. 10A is a front view of an embodiment of a knife 300, in accordance with aspects of inventive concepts herein. In some embodiments, such as the embodiment shown in FIG. 10A, the knife 300 comprises a first portion 310 and a second portion 320. In some embodiments, the first portion 310 functions as a handle for a user. The first portion 310 includes an opening through which a user's hand may extend. In some embodiments, such as the embodiments shown in FIG. 10, the knife 300 comprises a channel 330 between a portion of the first portion 310 and a portion of the second portion 320. In some embodiments, the channel 330 is configured to capture a portion of a material to be cut.

In some embodiments, such as the one shown in FIG. 10A, the knife 300 comprises a blade 340. In the embodiment shown in FIG. 10A, the blade 340 is coupled to the first portion 310 and the second portion 320. In alternative embodiments, the blade 340 is coupled to the first portion 310. In alternative embodiments, the blade 340 is coupled to the second portion 320. In some embodiments, the blade 340 is removably coupled to the knife 300.

In some embodiments, such as the one shown in FIG. 10A, the second portion 320 comprises a tapered end 325. In some embodiments, the tapered end 325 is configured to pierce a material, such as a curtain 10.

In some embodiments, such as the one shown in FIG. 10A, the first portion 310 comprises a rounded edge and an angled edge. The rounded edge forming the handle. The angled edge is parallel to an edge of the blade 340 with the channel 330 between a portion of the angled edge and the blade 340.

In some embodiments, such as the one shown in FIG. 10A, the second portion 320 comprises two substantially straight edges meeting at the tapered end 325.

In some embodiments, such as the one shown in FIG. 10A, a width of the channel 330 is narrower at the end of the channel 330 than it is near the entrance of the channel 330. In alternative embodiments, the channel 330 comprises different characteristics. In the embodiment shown in FIG. 10A, the entrance of the channel 330 is wider so that it is more likely to capture a portion of a material to be cut. In such embodiments, the channel 330 is narrower near the end of the channel opposite the entrance of the channel to ensure that the material is cut.

In use, the user grips the first portion 310 as a handle and pushes the end 325 into the material to be cut. The material to be cut is pierced by the end 325 and the material to be cut is guided into the channel 330. The blade 340 then cuts the material as the user pulls the handle 310. The blade 340 is between first portion 310 and the second portion 320 such that the blade is not exposed so that a user is protected from being cut by the blade 340. FIG. 10B is a perspective view of an embodiment of the magnetic door system 400 packaged as the kit 550, in accordance with aspects of inventive concepts herein. In the embodiment shown, the kit 550 comprises a magnetic door 100, a knife 300, and at least one attachment mechanism 200. The kit 550 is packaged in a receptacle 50. In the embodiment shown in FIG. 10B the attachment mechanism 200 comprises a roll of double-sided tape. In some embodiments, the kit 550 further comprises at least one roll of tape, for example, duct tape. In some embodiments, the kit also comprises at least one pole 30. In some embodiments, the kit also comprises one or more curtains 10. In some embodiments, the receptacle 50 comprises a container for storing the elements of the kit 550. In some embodiments, the receptacle 50 comprises one selected from the group consisting of a cardboard box, a paper box, a plastic container, a canvas bag and a cloth bag.

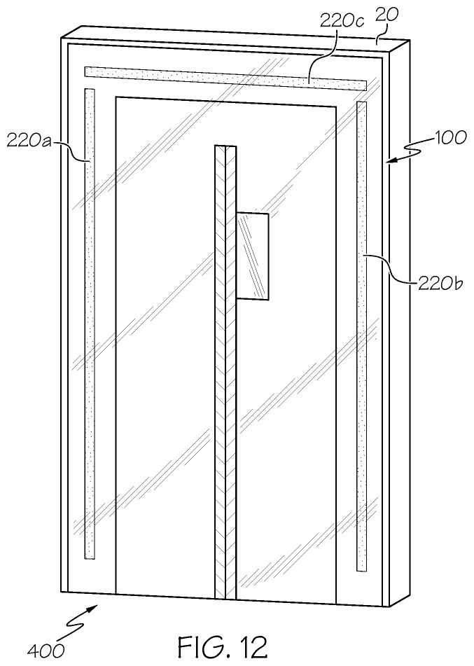

FIGS. 11A-C show an installer 40 installing an embodiment of a magnetic door 100 of FIG. 8, in accordance with aspects of inventive concepts herein. In the embodiments shown in FIGS. 11A-11C, the magnetic door 100 is mounted to a curtain 10. In alternative embodiments, the magnetic door 100 is mounted to a door frame 20, as seen in FIG. 12, or any other such suitable surface.

FIG. 11A shows a user installing first members of a magnetic door system of FIG. 8, in accordance with aspects of inventive concepts herein. FIG. 11B shows a user installing a second members of the magnetic door system of FIG. 8, in accordance with aspects of inventive concepts herein. FIG. 11C shows a user installing the magnetic door of the magnetic door system of FIG. 8, in accordance with aspects of inventive concepts herein.

FIG. 11A illustrates an installer 40 installing first members 210a, 210b, 210c of a magnetic door system 400 of FIG. 8, in accordance with aspects of inventive concepts herein. In FIG. 11A, the entryway opening 7 is cut using, for example, knife 300. In FIG. 11A, the installer 40 is installing first members 210a, 210b, 210c at desired locations around the entryway opening 7. In this embodiment, the first members 210a, 210b, 210c comprise duct tape. In alternative embodiments, the first members 210a, 210b, 210c comprise a different material. The first members may be installed at any location around a perimeter of the entryway opening 7. The number of first members 210 is not limited to those illustrated in FIG. 11A. That is, more or less first members 210 may be applied to the curtain 10.

FIG. 11B shows an installer 40 installing second members 220a, 220b, 220c of the magnetic door system 400 of FIG. 8, in accordance with aspects of inventive concepts herein.

In FIG. 11B, the second members 220a, 220b, 220c comprise double-sided tape. In this embodiment, before mounting, the double-sided tape 220 comprises tape liner 224 covering the side with high-tack adhesive material 222. In this embodiment, the tape liner 224 is removed during the installation process.

In this embodiment, the installer 40 is positioning each second member 220a, 220b, 220c at the position of a corresponding first member 210a, 210b, 210c. In this example, the installer 40 affixes the second member 220, for example, double-sided tape from the magnetic door system 400 to the corresponding first member 210 by placing the second side of the carrier material 221 having the low-tack adhesive material 223 thereon against the corresponding first member 210. For example, the installer 40 places a starting portion of the second member 220 at a top of the first member 210a at a side of the entryway opening 7, and applies a uniform pressure with a hand to the backside (i.e., first side of the second member 220 having the tape liner 224 that covers the high-tack adhesive material 222) of the second member 220 while applying a continuous strip of the second member 220 to the first member 210a in a downward direction toward a bottom of the first member 210a. The installer 40 can then tear by hand, or cut using a knife, cutter, scissors or blade, the second member 220. As a result, a first second member 220a, that is a first double-sided tape strip, is affixed to the first member 210a at a side of the entryway opening 7.

After mounting, the second members 220a, 220b and 220c on the respective first members 210a, 210b and 210c, the tape liner 224 is removed from each of the second members 220 a-c.

FIG. 11C shows a user installing the magnetic door 100 of the magnetic door system 400 of FIG. 8, in accordance with aspects of inventive concepts herein. In this view, the magnetic door 100 is coupled to the high-tack adhesive material 222 of the second members 220 a-c. In some embodiments, the magnetic door 100 is removably coupled to the first members 210 a-c. In some embodiments, the magnetic door 100 is removably coupled to the second members 220 a-c.

In this manner, embodiments of the present inventive concepts provide a double-sided tape having a low-tack side that prevents damage to surfaces when removed, and also having a high-tack side capable of securing a magnetic door 100 to surfaces, a door frame, a window frame, and the like. Embodiments of the present inventive concepts further provide a method of installing various partition configurations using the double-sided tape. Embodiments of the present inventive concepts further provide magnetic door kits that comprise components of magnetic door systems and tools for installing and assembling said magnetic door systems.

FIG. 12 is a perspective view of an embodiment of a magnetic door 100 coupled to a door frame 20, in accordance with aspects of inventive concepts herein. In some embodiments, such as the one shown in FIG. 12, the one or more attachment mechanisms 200 only comprise a second member 220. In some embodiments, such as the one shown in FIG. 12, the second member 220 comprises double-sided tape with the characteristics described in connection with

FIGS. 8-11C. In alternative embodiments, the magnetic door 100 is coupled to the door frame 20 using a first member 210 and a second member 220 in accordance with the method described in connection with FIGS. 8-11C.

In some embodiments, such as the one shown in FIG. 12, the double-side tape 220 directly couples the magnetic door 100 to a door frame 20. In alternative embodiments, the magnetic door 100 is coupled to a nearby surface or structure. In some embodiments, the magnetic door 100 is coupled to a head, rail, and/or pole similar or identical to those described in connection with patents and/or patent applications incorporated by reference herein.

In some embodiments, an outer edge of the magnetic door 100 comprises a sleeve configured such that a pole 30 or other such similar support may pass through.

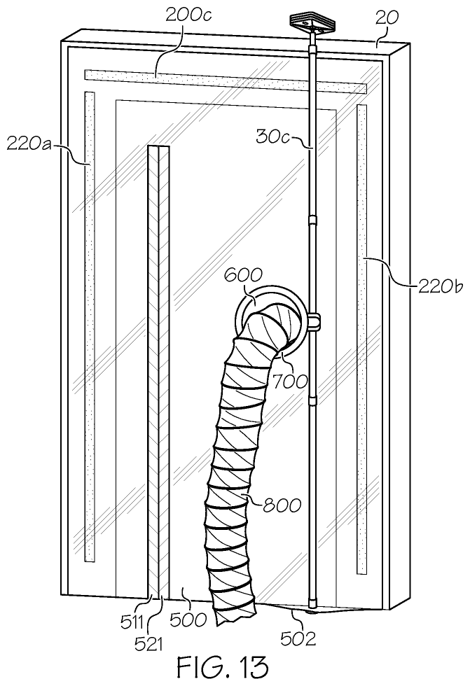

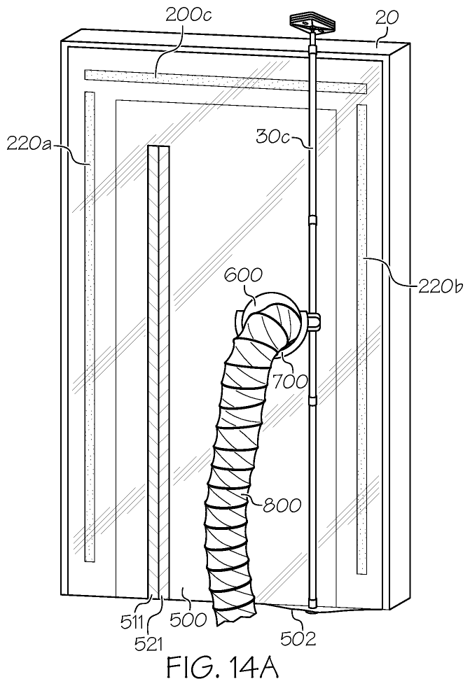

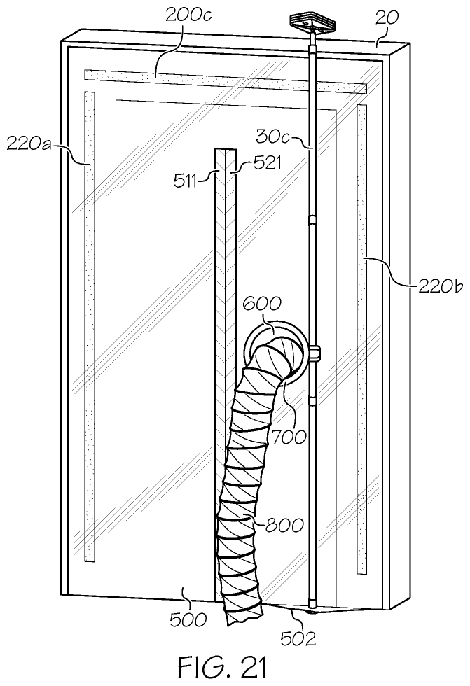

FIG. 13 is a perspective view of an embodiment of a magnetic door 500 with an aperture 600, in accordance with aspects of inventive concepts herein. In some embodiments, such as the embodiment shown in FIG. 13, the first seam 511 meets the second seam 521 at a position that is off-center relative to the width of the magnetic door 500. In the embodiment shown in FIG. 13, the seams meet at a position left of the center of the width of the magnetic door 500. In alternative embodiments, the seams meet at a position right of the center of the width of the magnetic door 500. In alternative embodiments, the seams meet at a position at or near the center of the width of the magnetic door 500, as illustrated in FIG. 21. In some embodiments, such as the embodiment shown in FIG. 13, the opening and closing of the magnetic door 500 operates in a manner as previously described herein. In some embodiments, such as the embodiment shown in FIG. 13, the first seam 511 and second seam 521 operate in a manner as previously described in connection with first seam 111 and second seam 121 of FIG. 8. In FIG. 13, the magnetic door 500 is applied to door frame 20, in accordance with the method described in connection with FIG. 12.

In some embodiments, such as the one shown in FIG. 13, the magnetic door 500 comprises at least one aperture 600. In the embodiment shown in FIG. 13, the magnetic door 500 comprises one aperture 600. In alternative embodiments, the magnetic door 500 comprises more than one aperture 600. In alternative embodiments, the magnetic door 500 does not comprise an aperture 600.

In some embodiments, such as the one shown in FIG. 13, the aperture 600 is positioned at a right side of the magnetic door 500. In alternative embodiments, at least one of the at least one aperture 600 is positioned at a left side of the magnetic door 500. In alternative embodiments, at least one of the at least one aperture 600 is positioned at the center of the magnetic door 500, as seen in FIG. 21.

In some embodiments, such as the embodiment shown in FIG. 13, the aperture 600 comprises the shape of a circle. In alternative embodiments, at least one of the at least one aperture 600 comprises a different shape, including but not limited to a square, rectangle, triangle, any other polygon, or combinations thereof.

In some embodiments, such as the embodiment shown in FIG. 13, the aperture 600 is positioned at a height of about 6 feet from the bottom edge 502 of the magnetic door 500; however, the present inventive concepts are not limited thereto. In alternative embodiments, the aperture 600 is at a different height relative to a bottom edge 502 of the magnetic door 500.

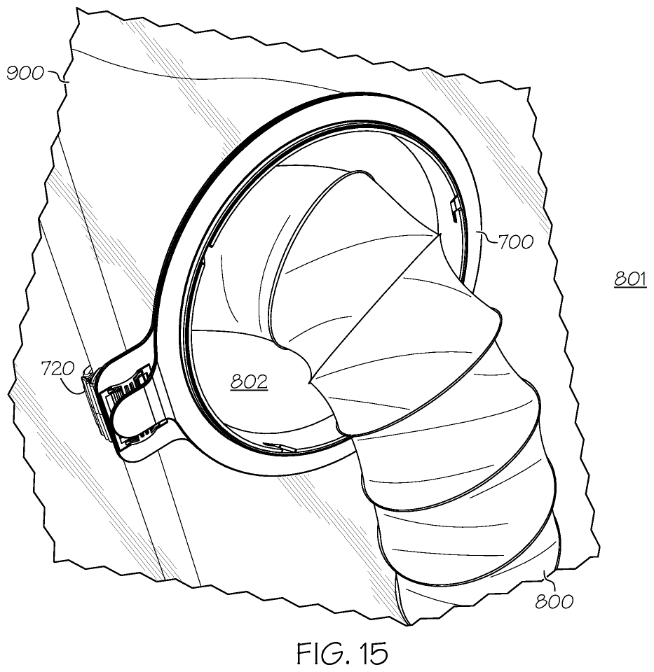

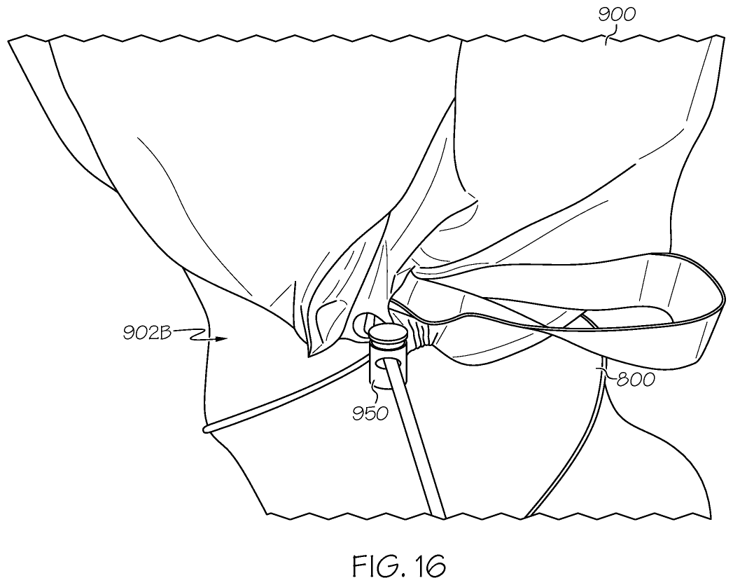

In some embodiments, the aperture 600 is constructed and arranged to allow for an air duct 800 to pass through. An air duct 800 allows for controlled air movement between first air region 801 and second air region 802, at opposite sides of the magnetic door 500, as seen in FIG. 15.

In some embodiments, such as the embodiment shown in FIG. 13, the air duct 800 is supported by a base 700. In some embodiments, the base 700 is configured to support the weight of any item passing through an aperture 600. In some embodiments, the base 700 is integral with the magnetic door 500. In some embodiments, such as the one shown in FIG. 13, the base 700 is coupled to a pole 30. In alternative embodiments, the base 700 comprises a first portion on a first side of the curtain 10 at the first air region 801 and a second portion on a second side of the curtain 10 at the second air region 802. In such embodiments, the first portion of the base 700 and the second portion of the base 700 may be configured to couple to each other with a portion of the magnetic door 500 between them. In some embodiments, the base 700 includes some or all of the characteristics described in connection with the housing frame of WO 2020/146904, which is incorporated herein by reference in its entirety.

In certain configurations, it may be desirable to position a flexible air duct 800 through the magnetic door 100 of the partition installation 1000 of FIG. 8 to allow presentation or removal of forced air or to from a region enclosed by the partition installation 1000. The magnetic door 500 of FIG. 13 having the aperture 600 and the base 700 may be applied to the partition installation 1000 rather than or in addition to magnetic door 100. In some cases, positioning of a flexible air duct 800 may be desired for ambient air ventilation of the region. Placement of the flexible air duct between the magnetic door 500 and an abutting surface can compromise the installation and/or can be unsightly. The aperture 600 and the base 700 allow a user to mount a flexible air duct 800 in an effective and slightly manner while achieving the desired air flow characteristics.

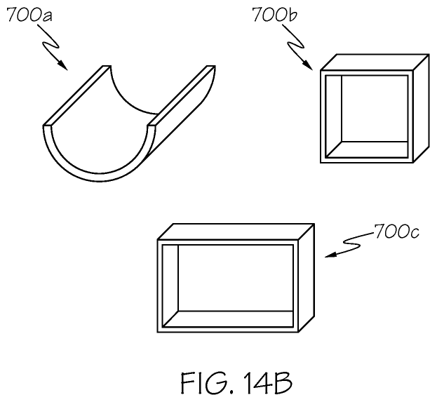

FIG. 14A is a perspective view of an embodiment of a magnetic door 500 with an aperture 600, in accordance with aspects of inventive concepts herein. In some embodiments, such as the embodiment shown in FIG. 14A, the base 700 comprises half a ring. In alternative embodiments, the base 700 comprises a channel. In alternative embodiments, the base 700 comprises a platform.

In some embodiments, such as the one shown in FIGS. 13 and 14A, the base 700 is coupled to a pole 30. In alternative embodiments, the base 700 is coupled to a door frame. In alternative embodiments, the base 700 is coupled to a neighboring surface. In alternative embodiments, the base 700 is coupled to the curtain 10. In alternative embodiments, the base 700 comprises a first portion and a second portion and a portion of the magnetic door 500 is secured between the first portion and the second portion, similar to the locking mechanism described in FIGS. 5B-7 in WO 2020/146904, which is incorporated by reference in its entirety herein. In some embodiments, the base 700 comprises a locking mechanism with one or more of the characteristics described in connection with FIGS. 5B-7 in WO 2020/146904, which is incorporated by reference herein in its entirety.

In some embodiments, such as the ones shown in FIGS. 13 and 14A, the base 700 is coupled to a neighboring surface (in this case a pole 30) using a base attachment mechanism 720. In some embodiments, such as the ones shown in FIGS. 13 and 14A, the base attachment mechanism 720 comprises a clamp. In alternative embodiments, the base attachment mechanism 720 comprises at least one type of tape. In some embodiments, the base attachment mechanism 720 comprises a hook and loop mechanism. In alternative embodiments, the base attachment mechanism 720 comprises one or more buttons. In alternative embodiments, the base attachment mechanism 720 comprises one or more magnets. In alternative embodiments, the base attachment mechanism 720 comprises one or more hooks. In alternative embodiments, the base attachment mechanism 720 comprises one or more pin and slot connectors. In some embodiments, the base attachment mechanism 720 comprises one or more staples. In alternative embodiments, the base attachment mechanism 720 comprises a locking mechanism comprises one or more of the characteristics described in connection with FIGS. 7-12 in WO 2020/223726, which is incorporated by reference herein in its entirety. In alternative embodiments, the base attachment mechanism 720 comprises glue, and/or any mechanism suitable for connecting two objects.

FIG. 14B shows different embodiments of a base 700, in accordance with aspects of inventive concepts herein. In some embodiments, the base 700 comprises a channel 700a. In some embodiments, the base 700 comprises a square shape 700b. In some embodiments, the base 700 comprises a rectangular shape 700c.

FIG. 15 is a perspective view of an embodiment of a flexible air duct 800 passing through the magnetic door 500, in accordance with aspects of inventive concepts herein. In some embodiments, such as the embodiment shown in FIG. 15, the magnetic door 500 comprises an enclosure 900. In the embodiment shown in FIG. 15, the flexible air duct 800 is supported by base 700 and passes through an enclosure 900. In some embodiments the enclosure 900 comprises a flexible fabric.

In some embodiments, such as the one shown in FIG. 15, the enclosure 900 is coupled to the magnetic door 500. In some embodiments, the enclosure 900 is sewn to the magnetic door 500 at or near at least a portion of an edge of the aperture 600. In some embodiments, the enclosure 900 is stitched to the magnetic door 500 at or near at least a portion of an edge of the aperture 600. In some embodiments, the enclosure 900 is coupled to the base 700. In some embodiments, the enclosure 900 is coupled to the base 700 at or near at least a portion of an edge of the aperture 600. In some embodiments, a first end of the enclosure 900 is coupled to the base attachment mechanism 720. In some embodiments, the enclosure 900 comprises one or more of the characteristics described in connection with the enclosure of WO 2020/146904, which is incorporated by reference herein in its entirety.

In some embodiments, the enclosure 900 comprises a retractable member 950, as seen in FIG. 16, that has an adjustable inner width so that the enclosure 900 can be sized to be tightened so as to accommodate flexible air ducts 800 of different outer widths. In this manner the base 700 and enclosure 900 can be adaptable to any of a number of different desired configurations.

In the embodiment, shown in FIG. 15, the base 700 is coupled to the left side of a magnetic door 500. In alternative embodiments, the characteristics described in connection with FIG. 15 are applicable to a base 700 coupled to the right side of magnetic door 500.

FIG. 16 is a perspective view of an embodiment of an enclosure 900 illustrating the tightening of a distal end 902B of the enclosure 900 about an outer surface of the body of the flexible air duct 800 using the retractable member 950, in accordance with aspects of inventive concepts herein. In the present embodiment, the retractable member 950 comprises a draw string positioned in an elongated pocket of the enclosure 900. A spring-loaded tab locks the length of the string once adjusted for size.

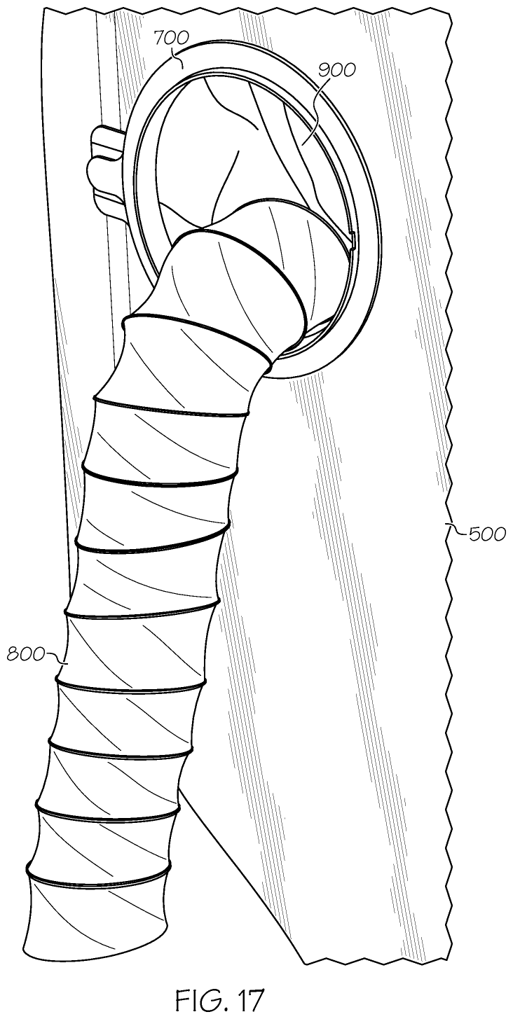

FIG. 17 is a perspective view of a resulting installation of the flexible air duct 800, in accordance with aspects of inventive concepts herein. In this figure, it can be seen that the configuration provides a mechanism for passage of the air duct 800 through the magnetic door 500. Accordingly, there is no need to interfere with the positioning of the magnetic door 500 along a neighboring surface. As a result, the magnetic door 500 installation is not compromised as a result of the presence of the flexible air duct 800. The resulting installation is also organized and attractive in appearance.

In the embodiment, shown in FIG. 17, the base 700 is coupled to the left side of a magnetic door 500. In alternative embodiments, the characteristics described in connection with FIG. 17 are applicable to a base 700 coupled to the right side of magnetic door 500.

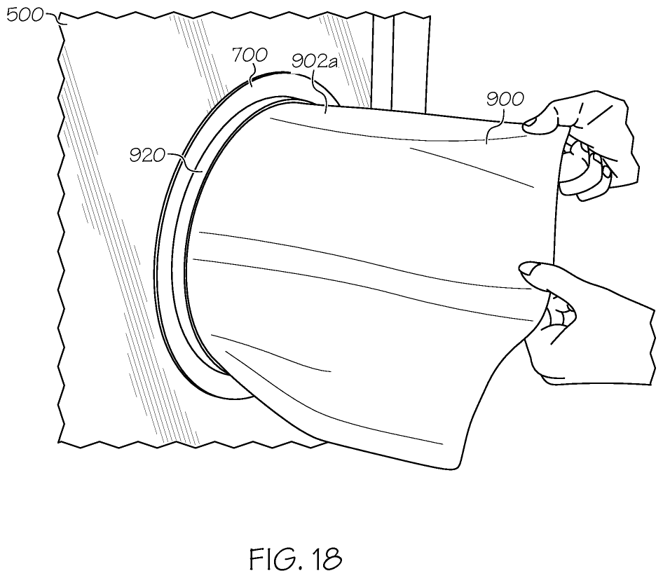

FIG. 18 is a perspective view of an embodiment of an enclosure 900 coupled to the base 700, in accordance with aspects of inventive concepts herein. In this embodiment, the enclosure 900 is coupled to the base 700 with coupling mechanism 920 comprising an adjustable hose clamp. A first end 902A, or proximal end of the enclosure 900 includes an opening that is sized to interface with an outer portion of an external flange of the base 700. In this embodiment, the outer portion of the external flange comprises a seat constructed and arranged to receive the first end 902A of the enclosure 900. The seat of the outer portion is of a sufficient width to receive the coupling mechanism 920.

In some embodiments, the enclosure coupling mechanism 920 comprises an elastic band that can be secured about the outer portion of the external flange. In some embodiments, the coupling mechanism 920 comprises an adjustable hose clamp that can be clamped about the outer portion of the external flange 714. In some embodiments, the enclosure coupling mechanism 920 comprises a ribbon that can be tensioned about the outer portion of the external flange. In some embodiments, the outer portion of the external flange includes a seat comprising a slotted frame for receiving and securing a coupling feature of the proximal end 902A of the enclosure 900.

In some embodiments, the enclosure 900 comprises a sock with first and second openings at the respective first and second ends, 902A, 902B. In some embodiments, the enclosure is cylindrical or semi-conical in shape.

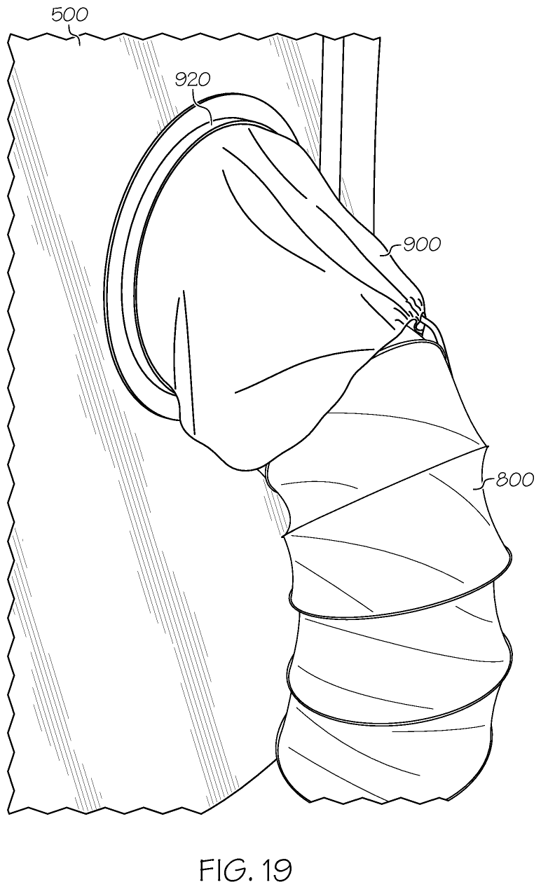

FIG. 19 is a perspective view of an embodiment of an air duct 800 and an enclosure 900 coupled to the base 700, in accordance with aspects of inventive concepts herein.

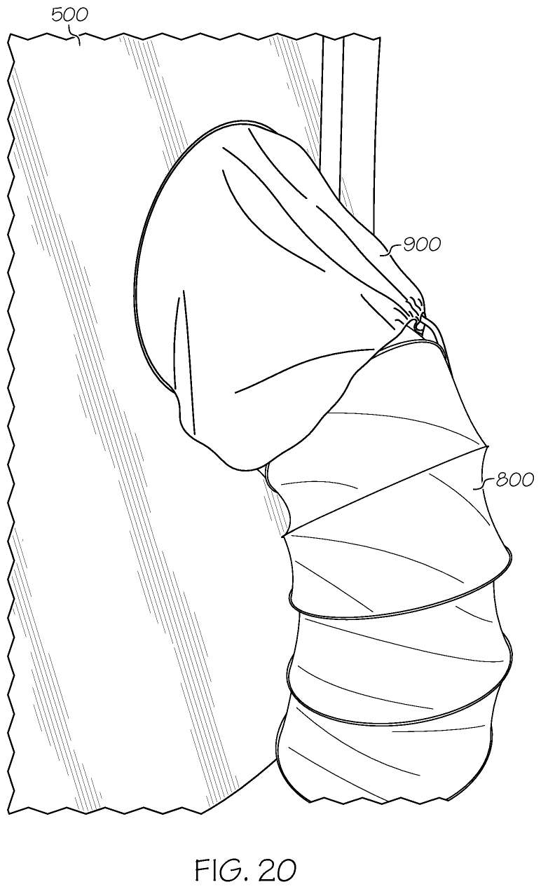

FIG. 20 is a perspective view of an embodiment of an air duct 800 and an enclosure 900 coupled to the magnetic door 500, in accordance with aspects of inventive concepts herein.

In some embodiments, a magnetic door kit comprises the magnetic door 500, at least one attachment mechanism 200, and the knife 300. In some embodiments, the attachment mechanism 200 comprises at least one roll of double-sided tape. In some embodiments, the magnetic door kit further comprises at least one roll of tape, for example, duct tape. In some embodiments, the magnetic door kit further comprises the curtain 10. In some embodiments, the magnetic door kit further comprises the curtain 10 and at least one pole 30a, 30b. In some embodiments, the magnetic door kit comprises the base 700 or an alternative base. In some embodiments, the magnetic door kit comprises a base 700 pre-attached to the magnetic door 500.

In some embodiments, the magnetic door 500 is integral with the curtain 10. In alternative embodiments, the magnetic door 500 comprises one or more of the characteristics described herein and is not integral with the curtain 10. In alternative embodiments, the magnetic door 500 comprises one or more of the characteristics described in connection with FIGS. 13-20, but is not integral with the curtain 10 and is coupled to a neighboring surface (e.g. curtain 10, door frame 20, etc.) using one or more of the characteristics described in connection with FIGS. 1-12.

In some embodiments, the magnetic door 100 includes one or more or the characteristics described in connection with an entryway apparatus of WO 2020/118277, which is incorporated herein by reference in its entirety. In some embodiments, the magnetic door 500 includes one or more or the characteristics described in connection with an entryway apparatus of WO 2020/118277, which is incorporated herein by reference in its entirety. In alternative embodiments, the magnetic door comprises at least one zipper.

In some embodiments, a magnetic door 100 is attached to the curtain 10 before the curtain 10 is installed at a site. In some embodiments, a magnetic door 500 is attached to the curtain before the curtain 10 is installed at a site.

In some embodiments, the first seam 111, 511 and second seam 121, 521 pairings of the magnetic door 100, 500 extend eight feet up from the bottom of the magnetic door 100, 500. In some embodiments, the first seam 111, 511 and second seam 121, 521 pairings extend length that is different than eight feet. In some embodiments, the first seam 111, 511 and second seam 121, 521 pairings do not extend to the bottom of the magnetic door 100, 500.

The magnetic door configuration previously described allows a user to use each first seam 111, 511 and second seam 121, 521 pairing as a single-slit doorway. Alternatively, a user could use different first seam 111, 511 and second seam 121, 521 pairings to construct a doorway, as described in WO 2017/117042, which is incorporated by reference in its entirety.

While inventive concepts have been particularly shown and described with references to embodiments thereof, it will be understood by those skilled in the art that various changes in form and detail may be made herein without departing from the spirit and scope of the inventive concepts as defined by the appended claims.

1. A magnetic door system, comprising:
a curtain;
a magnetic door removably coupled to the curtain, the magnetic door comprising:
a first seam, the first seam comprising a first magnet; and
a second seam, the second seam comprising a second magnet,
wherein the first and second magnets are constructed and arranged to be magnetically coupled, and
an attachment mechanism configured to couple the magnetic door to the curtain,
wherein the attachment mechanism is positioned between a surface of the curtain and a surface of the magnetic door.

2.-64. (canceled)
